(19) United States
(12) Patent Application Publication
(10) Pub. No.: US 2026/0340579 A1
(43) Pub. Date: Oct. 29, 2026

(54) SYSTEM

(71) Applicant: SoftBank Group Corp., Tokyo (JP)

(72) Inventor: Tadashi ABE, Tokyo (JP)

(73) Assignee: SoftBank Group Corp., Tokyo (JP)

(21) Appl. No.: 19/649,185

(22) Filed: Apr. 16, 2026

(30) Foreign Application Priority Data
Apr. 23, 2025 (JP) 2025-071590

(51) Int. Cl. G06Q 10/087; G05D 1/622; G05D 1/644; G05D 101/15; G05D 105/20; G05D 107/70; G05D 109/10; G06Q 10/047; G06Q 10/0631

(52) U.S. Cl. CPC G06Q 10/08726; G05D 1/622; G05D 1/644; G06Q 10/047; G06Q 10/06315; G06Q 10/08743; G05D 2101/15; G05D 2105/20; G05D 2107/70; G05D 2109/10

(57) ABSTRACT

The present invention relates to a system comprising a demand prediction unit, a procurement optimization unit, and an inventory simulation unit, configured to integrate supplier data, logistics data, sales data, inventory data, external environment data, and the like, automatically generate a demand prediction model using generative AI, and predict future demand with high accuracy. Furthermore, it is an invention that realizes unified and real-time optimization of the entire supply chain by automatically formulating a procurement plan by an optimization algorithm using generative AI in consideration of various parameters such as a procurement cost, a supply capacity, and a logistics lead time, simulating an inventory transition to quantitatively calculate an excess inventory or a stockout risk, and outputting an alert or a recommended action.

### CROSS-REFERENCE TO RELATED APPLICATION

The present application claims priority to and incorporates by reference the entire contents of Japanese Patent Application No. 2025-071590 filed in Japan on Apr. 23, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is, in addition to the conventional problem that inefficiencies such as delayed supply and demand adjustment, excess inventory, stockouts, and opportunity losses are likely to occur due to the fragmentation of information regarding the supply chain among a plurality of departments such as a purchasing department, a logistics department, and a business department, the problem that overall optimal decision-making is difficult because a wide variety of data such as supplier supply capacities, logistics lead times, demand fluctuations for each sales channel, and inventory status are individually managed, and furthermore, because procurement and inventory management depending on personal experience and intuition is performed, it is impossible to quickly and flexibly respond to external environment changes such as sudden demand fluctuations, supply disruptions, and logistics delays, resulting in cost increases due to excess inventory, sales opportunity losses due to stockouts, and a decrease in efficiency of the entire supply chain, and further the problem that it is difficult for conventional systems to seamlessly automate real-time data integrated analysis, advanced demand prediction, procurement optimization, and inventory simulation, making it impossible to realize the optimization of the entire supply chain.

### SUMMARY OF THE INVENTION

The present invention solves the problems by providing a supply chain optimization system comprising a demand prediction unit, a procurement optimization unit, and an inventory simulation unit, wherein the demand prediction unit is configured to integrate a plurality of types of supply chain-related data such as supplier data, logistics data, sales data, and inventory data, automatically generate a demand prediction model using generative AI with various factors such as past sales performance, inventory transitions, logistics lead times, supplier supply capacities, and demand fluctuations for each sales channel as input data, and predict a future demand quantity in real time with high accuracy, the procurement optimization unit is configured to automatically formulate a procurement plan by a linear programming method or other optimization algorithms using generative AI while considering constraint conditions such as a demand prediction value calculated by the demand prediction unit, a procurement cost for each supplier, a maximum procurable amount, a logistics cost, and a lead time, and calculate an optimal order quantity and order timing, and the inventory simulation unit is configured to simulate a future inventory transition using generative AI based on the procurement plan by the procurement optimization unit, the demand prediction value by the demand prediction unit, and a current inventory quantity, predict an excess inventory or a stockout risk, and output an alert or a recommended action for inventory optimization, thereby providing a means for analyzing information of the entire supply chain in real time and in a unified manner, seamlessly optimizing from demand prediction to procurement planning and inventory management, and realizing resolution of supply chain fragmentation, speeding up of supply and demand adjustment, and reduction of excess inventory and opportunity losses without depending on personal judgment or manual work.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

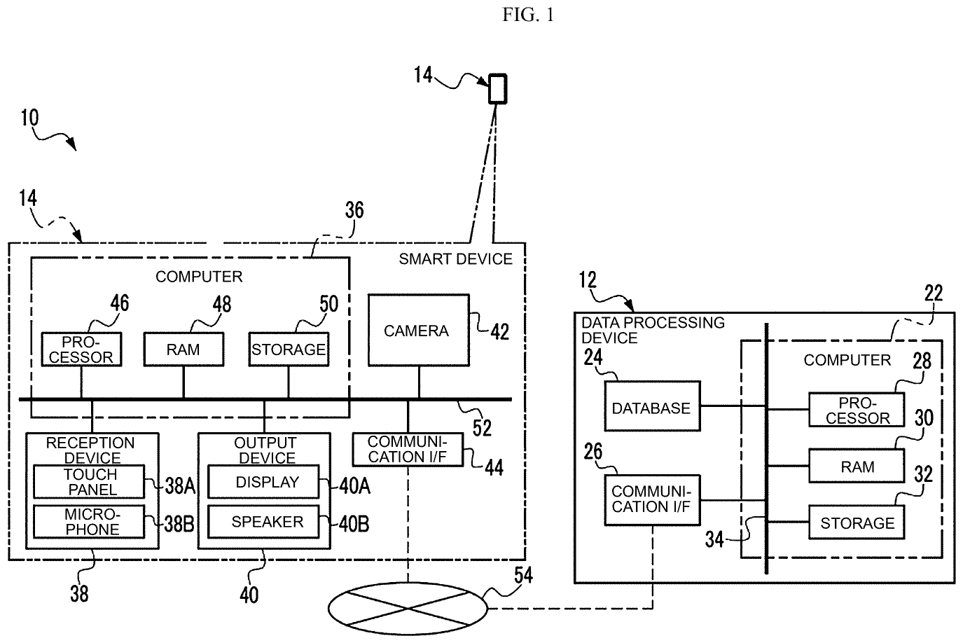

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

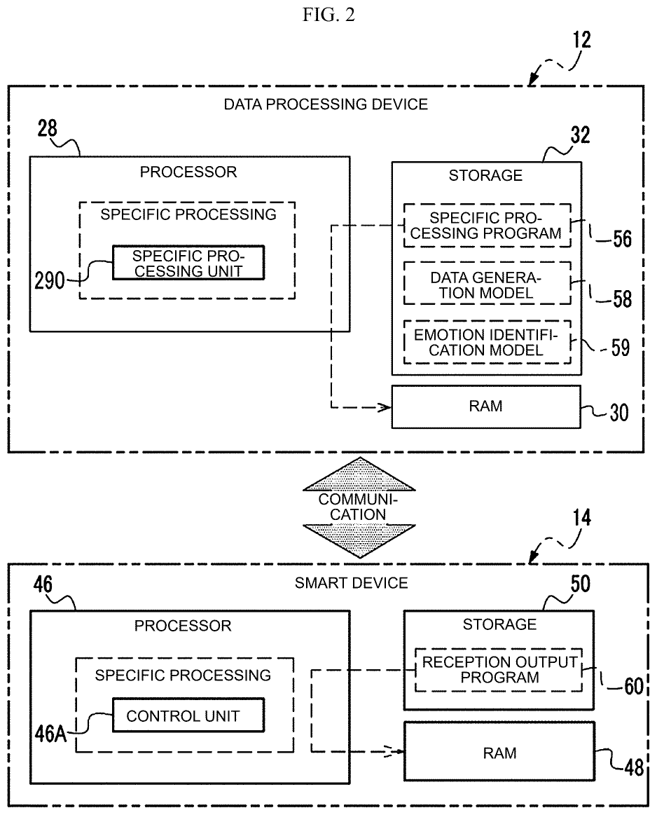

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The supply chain optimization system of the present invention has a demand prediction unit, a procurement optimization unit, and an inventory simulation unit as a core, and each of these units is mainly executed on a server, and a terminal is configured to play roles such as a user interface, data input/output, result visualization, and alert notification. Hereinafter, specific functions of each unit, a method of utilizing generative AI, role sharing between the server and the terminal, and various specific examples will be described. Specifically, the present system includes a parallel computing cluster composed of a plurality of computing nodes as the server. The server is equipped with a large number of graphics processing units. The server deploys artificial intelligence models such as a large language model and a time-series prediction model on a memory. The present system implements the demand prediction unit, the procurement optimization unit, and the inventory simulation unit as a microservice architecture. The present system executes each unit as an independent process using containerization technology. The present system transmits and receives high-dimensional tensor data at high speed between the respective units using an inter-process communication protocol. The terminal includes a computing device that executes a web browser or a dedicated application. The terminal connects to the server via a secure encrypted communication path. The terminal draws the user interface on a screen. The terminal detects an input operation from a user as an electrical signal. The terminal converts the detected input operation into structured data. The terminal transmits the structured data to the server. The server analyzes the received structured data. The server executes inference processing of the artificial intelligence model based on an analysis result. The server converts an inference result into drawing data for visualization. The server returns the drawing data to the terminal. The terminal updates a screen display based on the received drawing data. The present system adopts such a client-server method. The present system concentrates heavy computing processing on the server side. The present system significantly reduces a computing load on the terminal side. The present system improves a processing speed of the entire system. The present system optimizes utilization efficiency of hardware resources. The present system functions extremely effectively in use cases such as parts supply network management of a globally expanding manufacturing industry. The present system processes a huge amount of data generated from thousands of bases scattered around the world in real time. The present system supports optimization of the entire supply chain.

First, the demand prediction unit operates on the server and integrates a wide variety of data sources such as supplier data, logistics data, sales data, inventory data, and further external weather data, economic indicator data, trend data on SNS, and competitor trend data. For example, the sales data includes daily, weekly, and monthly sales quantities for each product, sales for each sales channel, special demand data during campaigns and sale periods, return and cancellation data, and the like. The logistics data includes a transport lead time of each product, an inventory movement history for each logistics base, a transport cost, a logistics delay occurrence history, transport obstacle information due to weather or disasters, and the like. The supplier data includes supplier supply capacities, a delivery date compliance rate, a procurement cost, a past supply delay history, a quality defect occurrence rate, availability of simultaneous procurement from a plurality of suppliers, and the like for each supplier. The inventory data includes an inventory quantity for each base, an inventory turnover rate, best-before/expiration date information, a disposal history, an inventory storage cost, an inventory movement history, and the like. Specifically, the demand prediction unit collects these wide variety of heterogeneous mixed data. The demand prediction unit executes data cleansing processing on the collected data. The demand prediction unit automatically complements missing values using a mean value complementation algorithm or a linear interpolation algorithm. The demand prediction unit converts character string data into a word embedding vector using natural language processing technology. The demand prediction unit standardizes numerical data so that a mean is zero and a variance is 1. The demand prediction unit combines the preprocessed data. The demand prediction unit constructs the combined data as a multidimensional input tensor. The demand prediction unit generates one-dimensional array data having, for example, sales quantities for the past 365 days as elements. The demand prediction unit generates a numerical vector having daily average temperatures and precipitations as elements. The demand prediction unit extracts an appearance frequency of a specific keyword on social media as a time-series array. The demand prediction unit combines these arrays and vectors to generate a three-dimensional input tensor. The demand prediction unit formats this input tensor as input data to the artificial intelligence model. The present system executes such strict data preprocessing. The present system dramatically improves learning efficiency of the artificial intelligence model. The present system prevents a decrease in prediction accuracy due to mixing of noise data. The present system improves quality of data management. The present system functions extremely effectively in use cases such as demand prediction of seasonal products in a retail industry. The present system automatically extracts meaningful feature amounts from a huge amount of history data. The present system realizes objective data analysis that does not rely on human intuition.

These diverse data are centrally collected and integrated on the server and input to the generative AI. The generative AI combines, for example, a deep learning model, a time-series prediction model, a natural language processing model, and the like, and learns a correlation with past sales performance and external factors. For example, it automatically extracts complex patterns such as how much demand for beverages and ice cream increases when the temperature rises sharply, how much the sales quantity increases when a specific product becomes a hot topic on SNS, and how much demand fluctuated when a promotion was implemented in the past. Furthermore, the generative AI learns irregular events such as sudden demand fluctuations and an epidemic of a new infectious disease from external data and past similar cases, and reflects them in the demand prediction model. For example, it is possible to learn how much logistics was delayed and demand for which product rapidly increased when a typhoon occurred in the past, and immediately correct the demand prediction when a typhoon occurs in the future. Specifically, the server executes a transformer-based neural network equipped with a self-attention mechanism. The neural network receives the input multidimensional time-series tensor. The neural network adds positional encoding to the input tensor. The neural network calculates dependencies of different time scales in parallel using a plurality of attention heads. The neural network maps, for example, a hidden correlation between a numerical vector of temperature and a time-series array of sales quantity on a high-dimensional space. The neural network receives an emotion score vector extracted from text data of social media as an input. The neural network calculates an inner product of the emotion score vector and past special demand data. The neural network iteratively updates weight parameters in the network using an error backpropagation method. The neural network uses a mean square error function as a loss function. The neural network executes a gradient descent method so that a value of the loss function is minimized. The neural network is stored on the memory as a trained model. The present system executes such non-conventional advanced mathematical operations. The present system captures minute fluctuation patterns that cannot be recognized by humans. The present system dramatically improves prediction accuracy. The present system brings about calculation efficiency. The present system functions extremely effectively in use cases such as production planning of fresh food in a food manufacturer. The present system directly contributes to reduction of disposal loss.

The demand prediction unit predicts a demand quantity of each product in an arbitrary period such as the next week, the next month, or a quarterly basis in real time using the model generated by the generative AI, and holds a result thereof on the server. Furthermore, it simultaneously calculates a reliability and a prediction error of the demand prediction, and automatically instructs collection of additional data and model retraining when the reliability is low. For example, for a new product with few similar sales patterns in the past, the generative AI utilizes sales data of similar products and market trend data to improve prediction accuracy. Specifically, the demand prediction unit inputs the latest input tensor to the trained neural network. The neural network executes a forward propagation operation. The neural network outputs a numerical vector indicating a future demand quantity from an output layer. The neural network simultaneously outputs probability distribution data indicating uncertainty of prediction. The demand prediction unit calculates a variance value of the output probability distribution. The demand prediction unit calculates a reciprocal of the variance value as a reliability score. The demand prediction unit outputs, for example, numerical data setting a sales prediction quantity for the next week to 5,000 pieces as an output value. The demand prediction unit simultaneously outputs numerical data setting the reliability score to 85 percent as a percentage. The demand prediction unit compares the calculated reliability score with a preset threshold value. The demand prediction unit determines whether or not the reliability score falls below the threshold value. When the reliability score falls below the threshold value, the demand prediction unit generates a retraining trigger signal as subsequent processing. The demand prediction unit transmits the retraining trigger signal to a data collection module. Upon receiving the signal, the data collection module automatically acquires the latest market trend data from an external database. The server executes fine-tuning of the neural network using the acquired new data. The present system includes such a dynamic self-evaluation and self-correction mechanism. The present system prevents obsolescence of the prediction model. The present system always maintains high prediction accuracy. The present system exhibits a clear technical effect of error reduction. The present system functions extremely effectively in use cases such as determining an initial order quantity of a new product in an apparel industry. The present system minimizes an inventory risk.

Next, the procurement optimization unit integrates various parameters such as the future demand prediction value calculated by the demand prediction unit, a procurement cost for each supplier, a maximum procurable amount, a logistics cost, a lead time, supplier supply stability, a past delivery date compliance rate, availability of distributed procurement from a plurality of suppliers, procurement budget constraints, exchange rate fluctuations, raw material price fluctuations, supplier credit risks, and disaster risks on the server, and inputs them to the generative AI. The generative AI automatically selects and applies an optimization method such as reinforcement learning, an evolutionary algorithm, or a mixed integer programming method, for example, and calculates an optimal procurement plan that simultaneously satisfies a plurality of objective functions such as minimization of procurement costs, dispersion of supply risks, maximization of a delivery date compliance rate, and optimization of an inventory turnover rate. Specifically, the procurement optimization unit receives a prediction quantity vector output from the demand prediction unit. The procurement optimization unit generates a multidimensional state vector having attribute data of each supplier as elements. The procurement optimization unit inputs the state vector to a reinforcement learning agent. The reinforcement learning agent executes a policy gradient method algorithm based on a Markov decision process. The reinforcement learning agent selects an optimal action vector from an action space based on the current state vector. The action vector includes an order quantity and an order timing for each supplier as elements. The procurement optimization unit executes a virtual procurement simulation based on the selected action vector. The procurement optimization unit calculates a procurement cost, a supply risk, and a delivery date compliance rate from a simulation result. The procurement optimization unit calculates a value of a reward function by weighting and adding the calculated respective indices. The reinforcement learning agent updates weights of an internal neural network so that the value of the reward function is maximized. The procurement optimization unit repeats this trial-and-error process tens of thousands of times. The procurement optimization unit searches for a set of Pareto optimal solutions. The procurement optimization unit outputs structured data indicating an optimal order quantity and order timing as a final output. The present system executes such a multi-objective optimization operation in a high-dimensional space. The present system derives an optimal solution at a speed far exceeding human calculation ability. The present system realizes processing speed improvement and calculation efficiency. The present system functions extremely effectively in use cases such as parts procurement from a plurality of suppliers in an electronic parts manufacturer. The present system enhances resilience of the supply chain.

For example, when a prediction that demand for a certain product will rapidly increase is issued, the generative AI automatically determines an optimal order quantity and order timing by combining simultaneous ordering from a plurality of suppliers, shortening of a logistics lead time, utilization of emergency transport means, switching of procurement sources, optimization of inventory movement, and the like. In addition, the procurement optimization unit learns and reflects changes in an external environment such as exchange rate fluctuations, a sudden rise in raw material prices, supplier disaster risks, and geopolitical risks in real time by the generative AI, and flexibly corrects the procurement plan. For example, when an earthquake occurs in a region where a main supplier is located, the generative AI can immediately propose switching orders to a supplier in another region, and automatically plan up to reconstruction of a logistics route and arrangement of emergency transport means. Specifically, the procurement optimization unit receives streaming data from an external news distribution application programming interface. The procurement optimization unit inputs the received text data to a natural language processing model. The natural language processing model outputs label data indicating a fact of disaster occurrence and an occurrence region from the text data. The procurement optimization unit rewrites a supplier supply capacity parameter in the corresponding region to zero based on the output label data. The procurement optimization unit generates a new state vector including the updated parameter. The procurement optimization unit re-inputs the new state vector to the reinforcement learning agent. The reinforcement learning agent outputs a new action vector with a response speed in milliseconds. The action vector includes numerical data indicating an order quantity to an alternative supplier and categorical data designating emergency air transport. The procurement optimization unit transmits the output action vector to a subsequent processing module. The subsequent processing module analyzes the action vector. The subsequent processing module transmits a control signal for automatic ordering to a system of the alternative supplier. The present system executes real-time inference processing under such a dynamic environment. The present system immediately adapts to rapid changes in the external environment. The present system prevents disruption of the supply chain. The present system brings about technical effects of communication load reduction and processing automation. The present system functions extremely effectively in use cases such as maintenance of a just-in-time production system in an automobile industry. The present system reduces a risk of production line stoppage to the utmost limit.

The inventory simulation unit integrates various parameters such as the procurement plan by the procurement optimization unit, the demand prediction value by the demand prediction unit, a current inventory quantity, a logistics lead time, a supplier supply delay risk, a demand distribution for each sales channel, an inventory storage cost, a disposal risk, best-before date information, an inventory movement cost, an inter-base inventory movement history, past stockout histories, and an excess inventory occurrence history on the server, and inputs them to the generative AI. Based on these parameters, the generative AI simulates a future inventory transition at an arbitrary granularity such as a daily basis, a weekly basis, or a monthly basis, and quantitatively calculates an occurrence probability of an excess inventory or a stockout risk. For example, when a procurement lead time is long relative to the demand prediction value, it automatically detects that a stockout risk increases and issues an alert. In addition, when an inventory becomes excessive, it automatically presents a recommended action such as discount sales, inventory movement to another base, a disposal avoidance measure, or a promotion proposal. Furthermore, the generative AI also learns a response history when a stockout or an excess inventory occurred in the past, and can propose an optimal response measure in real time when a similar situation occurs. Specifically, the inventory simulation unit models each parameter as a probability distribution function. The inventory simulation unit executes a probabilistic simulation engine based on a Monte Carlo method. The simulation engine generates tens of thousands of future scenarios in parallel using a random number generator. The simulation engine calculates daily inventory transitions in each scenario. The simulation engine counts the number of scenarios in which the inventory quantity falls below zero. The simulation engine calculates a ratio to the total number of scenarios as a stockout risk probability score. The simulation engine outputs, for example, a stockout risk probability score for the next month of a specific product as numerical data of 0.85. The inventory simulation unit compares the calculated probability score with a preset warning threshold value. When the probability score exceeds the warning threshold value, the inventory simulation unit activates an alert generation module as subsequent processing. The inventory simulation unit simultaneously outputs label data of a recommended action using a generative adversarial network. The label data includes, for example, an identifier indicating an inventory transfer from another base. The present system executes such an advanced probabilistic operation at high speed inside a computer. The present system quantifies a complex risk that cannot be predicted by human intuition. The present system realizes improvement of calculation accuracy and automation of risk management. The present system functions extremely effectively in use cases such as inventory management of products with expiration dates in a pharmaceutical wholesale industry. The present system achieves both reduction of disposal costs and prevention of stockouts.

For example, when a stockout is likely to occur at a specific base, the generative AI analyzes an inventory status of other bases and automatically generates an optimal inventory movement plan. In addition, when there is a large amount of inventory whose best-before date is approaching, it automatically performs discount sales, implementation of a promotion, and proposal of a disposal avoidance measure. Furthermore, when a logistics delay occurs, it learns past delay patterns and histories of alternative logistics routes, and proposes an optimal alternative means. Specifically, the inventory simulation unit generates graph structure data having position information and inventory quantities of all bases as node feature amounts. The inventory simulation unit adds a transport cost and a lead time between bases as edge feature amounts. The inventory simulation unit inputs this graph structure data to a graph neural network. The graph neural network executes a message passing algorithm. The graph neural network exchanges and aggregates feature amount vectors between adjacent nodes. The graph neural network updates a hidden state vector of each node. The graph neural network outputs an edge weight score indicating an optimal inventory movement route from an output layer. The inventory simulation unit selects a route having a maximum weight score. The inventory simulation unit outputs the selected route as structured data of an optimal inventory movement plan. The structured data includes, for example, an instruction content to move 100 pieces of product C from base A to base B. The inventory simulation unit transmits this structured data to a logistics management system. The logistics management system automatically executes vehicle allocation processing of delivery trucks based on the received data. The present system adopts such a non-conventional processing method based on graph theory. The present system instantly solves an optimization problem on a complex network. The present system brings about technical effects of minimization of logistics costs and maximization of delivery efficiency. The present system functions extremely effectively in use cases such as inter-store inventory accommodation of a convenience store chain expanding nationwide. The present system dramatically reduces opportunity loss.

On the terminal side, persons in charge of a purchasing department, a logistics department, and a business department can browse results of demand prediction, a procurement plan, and inventory simulation executed on the server in a dashboard or report format, and for example, a demand prediction graph of each product, a procurement plan table, an inventory transition simulation result, a risk alert list, a recommended action list, and the like are visualized. The person in charge can also input information such as a new sales plan, promotion information, new addition of a supplier, a logistics route change, an inventory movement instruction, and an emergency order instruction from the terminal, and these pieces of information are reflected in the generative AI on the server in real time. For example, when a sudden promotion implementation is determined, by inputting the information from the terminal, the generative AI immediately retrains the demand prediction model and automatically updates the procurement plan and the inventory simulation. Specifically, the terminal establishes an always-connected bidirectional communication channel with the server using a WebSocket protocol. The terminal receives drawing data in a JSON format transmitted from the server. The terminal analyzes the drawing data using a built-in rendering engine. The terminal draws an interactive graph or table on a display based on an analysis result. The terminal detects promotion information input by a user via a touch panel or a keyboard as an electrical signal. The terminal converts the detected information into structured data consisting of key-value pairs. The terminal immediately transmits the structured data to the server via the bidirectional communication channel. The server merges the received structured data into an input tensor on a memory. The server executes online learning of a neural network using the updated input tensor. The server fine-tunes weight parameters of the network using a gradient descent method. The server recalculates a demand prediction score using the fine-tuned model. The server push-delivers a recalculated result to the terminal as new drawing data. The terminal asynchronously updates a screen display based on the received new drawing data. The present system adopts such an event-driven asynchronous communication architecture. The present system shortens a delay time from a user operation to a screen update to a millisecond unit. The present system minimizes consumption of a communication band. The present system realizes improvement of user experience and improvement of system responsiveness. The present system functions extremely effectively in use cases such as control tower operations serving as a command tower of a large-scale retail industry. The present system strongly supports rapid decision-making.

In addition, utilization of the generative AI is not limited to mere prediction and optimization, but covers a wide range of fields such as, for example, anomaly detection, automatic generation of response measures at the time of anomaly, scenario analysis of the entire supply chain, proposal of inventory relocation among a plurality of bases, proposal of minimization of CO2 emissions of the entire supply chain, automatic generation of a supplier evaluation model, risk management of the entire supply chain, automatic recovery plan generation at the time of disaster occurrence, and emergency procurement scenario generation at the time of rapid demand increase. For example, when logistics delays occur frequently, the generative AI learns past delay patterns, issues a risk alert before a delay occurs, and automatically proposes an alternative logistics route and an emergency transport means. Furthermore, it is also possible to generate a plurality of scenarios in which a supply-demand balance of the entire supply chain is significantly disrupted, and simulate an optimal response measure for each. Specifically, the server executes an unsupervised learning model called an autoencoder. The autoencoder is composed of an encoder network and a decoder network. The encoder network receives supply chain operation data in a normal state as an input. The encoder network compresses the input data into a low-dimensional latent space vector. The decoder network reconstructs original input data from the latent space vector. The server inputs real-time operation data to the autoencoder. The server calculates a reconstruction error between the input data and the reconstructed data. When the reconstruction error exceeds a predetermined threshold value, the server determines that an abnormal state has occurred. Upon detecting the abnormal state, the server inputs the latent space vector to a conditional generative adversarial network. The generative adversarial network generates a plurality of response measure scenarios for resolving the abnormal state as text data. The generative adversarial network outputs a natural language text instructing, for example, securing of an alternative transport route or switching of a production line. The server converts the output text data into a structured command using a natural language processing model. The server transmits the structured command to a related subsystem. The present system includes such an advanced anomaly detection and self-repair mechanism. The present system maintains soundness of the system without human monitoring. The present system realizes minimization of downtime and reduction of operation costs. The present system functions extremely effectively in use cases such as raw material procurement network management of a globally expanding chemical manufacturer. The present system guarantees stable operation of a complex supply chain.

Furthermore, the system on the server cooperates with various databases and external APIs, and performs data cooperation in real time with, for example, a POS system, an inventory management system, a logistics management system, an accounting system, an external weather information service, an economic indicator database, an SNS analysis service, and the like. Thereby, the generative AI performs learning and inference based on the latest information at all times, and continuously realizes optimization of the entire supply chain. Specifically, the server adopts a microservice architecture including an application programming interface gateway. The gateway centrally manages data acquisition requests from external systems. The server executes a distributed streaming processing platform. The platform provides a messaging queue based on a publish-subscribe model. The server publishes transaction data transmitted from a point-of-sale information management system to the queue in real time. The server publishes numerical data of precipitation and temperature acquired from the weather information service to another queue. A data preprocessing worker process in the server asynchronously subscribes to data from these queues. The worker process combines the received data on a memory. The worker process converts the combined data into a time-series tensor. The worker process transfers the converted tensor to an inference engine of an artificial intelligence model. The inference engine immediately recalculates a prediction score based on the latest tensor data. The system constructs such a scalable data pipeline. The system processes tens of thousands of data streams per second without delay. The system eliminates a bottleneck in data processing. The system realizes maximization of hardware utilization efficiency by dynamic allocation of calculation resources. The system functions extremely effectively in use cases such as cooperation with an integrated core business system of a multinational corporation. The system strongly promotes data-driven management of the entire corporation.

As described above, in the embodiment of the present invention, each function of the demand prediction unit, the procurement optimization unit, and the inventory simulation unit is realized on the server using the generative AI, and the terminal is configured to play roles such as a user interface, data input/output, result visualization, and alert notification, whereby information on the entire supply chain is analyzed centrally in real time, and everything from demand prediction to a procurement plan, inventory management, and risk response is optimized consistently, and without depending on personal judgments or manual work, it is possible to realize elimination of supply chain fragmentation, speeding up of supply and demand adjustment, reduction of excess inventory and opportunity loss, and construction of a totally optimized supply chain. Specifically, the system dynamically manages each functional module on a cluster using a container orchestration tool. The system automatically increases or decreases the number of replicas of each module according to a load status. The system offloads inference processing of the artificial intelligence model to parallel calculation cores of a graphics processing unit. The system reduces a load on a central processing unit. The system optimizes data arrangement on a memory. The system improves a cache hit rate. The system combines these hardware-level optimization technologies. The system improves a processing speed by several tens of times compared to a conventional rule-based system. The system reduces power consumption. The system meets a demand for green computing. The system simultaneously processes a huge number of variables exceeding human cognitive limits. The system prevents falling into a local optimal solution. The system stably derives a global optimal solution. The system exhibits a clear technical effect of improving computer technology itself. The system functions extremely effectively in use cases of supply chain management in a wide range of industrial fields from manufacturing to retail. The system contributes to construction of next-generation intelligent social infrastructure.

### System Configuration

The system according to the present embodiment comprises a demand prediction unit, a procurement optimization unit, an inventory simulation unit, a data integration unit, a user interface unit, an alert notification unit, and an external cooperation unit. The demand prediction unit has a function of receiving various data such as sales performance data, supplier data, logistics data, inventory data, and further weather data, economic indicator data, SNS trend data, and competitor trend data as input, automatically generating a demand prediction model using generative AI, and predicting a future demand quantity with high accuracy and in real time. For example, weekly sales performance of beverage products for the past three years, temperature transitions in summer, the amount of topics of the corresponding product on SNS, new release information of competitor products, and the like are simultaneously input, and the generative AI outputs a prediction such as “there is a high possibility that beverage demand this summer will increase by 20% compared to normal years”. In addition, the demand prediction unit also learns a sales increase rate when a promotion is implemented, demand fluctuations when a logistics delay occurs, a sudden demand increase when an event is held in a specific region, and the like, and performs a prediction taking these complex factors into account. Furthermore, the demand prediction unit also has a function of calculating a reliability of a prediction result, and automatically instructing collection of additional data and model retraining when the reliability is low. Specific examples of a prompt sentence to be read by the generative AI include “Predict a weekly demand quantity for each product for the next three months based on sales performance data for the past three years, temperature data, SNS trend data, and competitor trend data. In particular, model with an emphasis on demand fluctuations in weeks when the temperature exceeds 30 degrees or weeks when topics rapidly increase on SNS.” and the like. Specifically, the demand prediction unit converts the input prompt sentence into an integer token ID array using a tokenizer. The demand prediction unit inputs the token ID array to an embedding layer. The embedding layer maps each token to a high-dimensional continuous vector representation. The demand prediction unit inputs the continuous vector representation to a self-attention mechanism block of a large language model. The self-attention mechanism block calculates a relevance between each word in a context. The large language model integrates a semantic relationship between the input numerical data and text data on a latent space. The large language model sequentially generates a probability distribution of text tokens indicating the prediction result from an output layer. The demand prediction unit inputs the generated text data to a parser. The parser extracts numerical data of a predicted quantity and percentage data of an increase rate from the text. The demand prediction unit converts the extracted data into structured data in a JSON format. The demand prediction unit outputs structured data including, for example, a product ID, a predicted quantity, and a reliability score. The demand prediction unit transmits this structured data to the subsequent procurement optimization unit. The system executes such a fusion technology of natural language processing and numerical prediction. The system extracts a quantitative prediction value from unstructured data with high accuracy. The system dramatically improves flexibility and expandability of data processing. The system functions extremely effectively in use cases such as summer production planning in a beverage manufacturer. The system prevents loss of sales opportunities due to stockouts.

The procurement optimization unit has a function of integrating various parameters such as the future demand prediction value calculated by the demand prediction unit, a procurement cost for each supplier, a maximum procurable amount, a logistics cost, a lead time, supplier supply stability, a delivery date compliance rate, availability of distributed procurement from a plurality of suppliers, procurement budget constraints, exchange rate fluctuations, raw material price fluctuations, supplier credit risk, and disaster risk, and automatically formulating an optimal procurement plan using generative AI. For example, when a prediction that demand for beverage products will rapidly increase is issued, the procurement optimization unit determines an optimal order quantity and order timing by combining simultaneous ordering from a plurality of suppliers, shortening of a logistics lead time, utilization of emergency transportation means, switching of procurement sources, optimization of inventory movement, and the like. In addition, it also learns and reflects changes in the external environment such as exchange rate fluctuations, a sudden rise in raw material prices, and supplier disaster risk in real time, and flexibly corrects the procurement plan. Furthermore, the procurement optimization unit performs multi-objective optimization for simultaneously satisfying a plurality of objective functions such as dispersion of supply risk, maximization of a delivery date compliance rate, and optimization of an inventory turnover rate. Specific examples of a prompt sentence to be read by the generative AI include “Formulate a procurement plan that minimizes procurement costs, disperses supply risk, and maximizes a delivery date compliance rate, considering the demand quantity for the next month output by the demand prediction unit, the procurement cost of each supplier, the maximum procurable amount, the logistics cost, the lead time, the supply stability, the delivery date compliance rate, exchange rate fluctuations, raw material price fluctuations, and disaster risk. Distributed procurement from a plurality of suppliers is also allowed.” and the like. Specifically, the procurement optimization unit combines the prompt sentence and various parameters and inputs them to the large language model. The large language model analyzes the input constraint conditions. The large language model internally executes logical inference steps for solving a constraint satisfaction problem. The large language model generates an intermediate inference process using a method called chain of thought. The large language model generates text data describing a specific procurement plan as a final output. The procurement optimization unit executes regular expression matching on the generated text data. The procurement optimization unit extracts a supplier ID, an order quantity, and a desired delivery date from the text. The procurement optimization unit converts the extracted data into a structured payload for automatic ordering. The procurement optimization unit generates a payload including an order instruction of, for example, 10,000 pieces for supplier A and 5,000 pieces for supplier B. The procurement optimization unit transmits this payload to an external electronic data interchange system. The system combines such specification of constraint conditions by natural language and automatic code generation. The system eliminates the need for programming complex optimization algorithms. The system significantly reduces costs of system development and maintenance. The system functions extremely effectively in use cases such as parts procurement in an assembly manufacturing industry that performs high-mix low-volume production. The system realizes complete automation of procurement operations.

The inventory simulation unit has a function of integrating various parameters such as the procurement plan by the procurement optimization unit, the demand prediction value by the demand prediction unit, the current inventory quantity, a logistics lead time, a supplier supply delay risk, a demand distribution for each sales channel, an inventory storage cost, a disposal risk, expiration date information, an inventory movement cost, an inter-base inventory movement history, past stockout histories, and excess inventory occurrence histories, simulating a future inventory transition at an arbitrary granularity such as a daily basis, a weekly basis, or a monthly basis using generative AI, and quantitatively calculating an occurrence probability of an excess inventory or a stockout risk. For example, when a procurement lead time is long relative to the demand prediction value, it automatically detects that the stockout risk increases, and issues an alert. In addition, when the inventory becomes excessive, it automatically presents a recommended action such as discount sales, inventory movement to another base, a disposal avoidance measure, and a promotion proposal. Furthermore, it also learns response histories when past stockouts or excess inventories occurred, and proposes an optimal response measure in real time when a similar situation occurs. Specific examples of a prompt sentence to be read by the generative AI include “Simulate a daily inventory transition for the next month based on the procurement plan output by the procurement optimization unit, the demand prediction value output by the demand prediction unit, the current inventory quantity, the logistics lead time, the supply delay risk, the demand distribution for each sales channel, the inventory storage cost, and the expiration date information, issue an alert when the stockout risk increases, and present a recommended action such as discount sales or inventory movement when an excess inventory occurs.” and the like. Specifically, the inventory simulation unit inputs time-series numerical data together with the prompt sentence to the large language model. The large language model autoregressively predicts a transition pattern of the numerical data. The large language model outputs a predicted value of a daily inventory quantity as a comma-separated numerical list. The large language model simultaneously outputs text of risk evaluation and text of a recommended action. The inventory simulation unit stores the output numerical list in a memory as array data. The inventory simulation unit determines whether or not a minimum value in the array becomes zero or less. The inventory simulation unit sets a stockout flag to true when the minimum value becomes zero or less. The inventory simulation unit transmits an emergency message to the alert notification unit as subsequent processing when the stockout flag is true. The inventory simulation unit extracts a specific command character string from the text of the recommended action. The inventory simulation unit extracts a parameter of, for example, a discount rate of 20 percent. The inventory simulation unit transmits this parameter to a sales management system. The system seamlessly links such text generation of a simulation result and extraction of structured data. The system eliminates a time lag from simulation to execution. The system brings about a technical effect of speeding up business processes. The system functions extremely effectively in use cases such as inventory management of a supermarket handling fresh food. The system minimizes disposal loss due to a decrease in freshness.

The data integration unit has a function of collecting data from various data sources such as sales performance data, supplier data, logistics data, inventory data, weather data, economic indicator data, SNS trend data, and competitor trend data, performing preprocessing such as format conversion, data cleansing, missing value complementation, time-series matching, and data normalization, and centrally storing the data on the server in a form usable by each unit. For example, sales data acquired from a POS system, inventory data acquired from a logistics management system, and weather data acquired from an external API are matched in time series, and converted into a format that is easy for generative AI to learn. In addition, the data integration unit also performs detection of abnormal values of data, elimination of duplicate data, automatic mapping of data, and the like, and maintains data quality. Furthermore, the data integration unit manages an update frequency and an acquisition timing of data, and ensures real-time performance. Specifically, the data integration unit executes an extract, transform, load pipeline. The data integration unit extracts data in parallel from a plurality of data sources using a distributed processing framework. The data integration unit develops the extracted data on an in-memory data grid. The data integration unit applies a data type conversion function to convert character string date data into an integer value of a UNIX timestamp. The data integration unit determines and eliminates duplication of records at high speed using a hash function. The data integration unit executes a statistical outlier detection algorithm. The data integration unit detects a numerical value exceeding three times a standard deviation as an abnormal value. The data integration unit replaces the abnormal value with the latest normal value. The data integration unit resamples time-series data having different sampling rates to the same time resolution by linear interpolation. The data integration unit stores the preprocessed data in a column-oriented database. The data integration unit executes a data write operation as asynchronous batch processing. The system makes full use of such advanced data engineering technology. The system processes petabyte-class large-scale data with low delay. The system eliminates an input/output bottleneck of storage. The system realizes improvement of a data search speed and saving of storage capacity. The system functions extremely effectively in use cases such as a manufacturing industry under an Internet of Things environment that collects a wide variety of sensor data. The system automates construction and operation of a data lake.

The user interface unit has a function of enabling persons in charge of a purchasing department, a logistics department, and a business department to view results of demand prediction, a procurement plan, and inventory simulation executed on the server in a dashboard or report format, and visualizing a demand prediction graph of each product, a procurement plan table, an inventory transition simulation result, a risk alert list, a recommended action list, and the like. For example, the person in charge can input information such as a new sales plan, promotion information, new addition of a supplier, a logistics route change, an inventory movement instruction, and an emergency order instruction from the terminal, and these pieces of information are reflected in the generative AI on the server in real time. The user interface unit also has intuitive operability, multilingual support, mobile terminal support, voice input support, and the like, and can be used by a wide range of users from field personnel to management. Specifically, the user interface unit is implemented as a single-page application. The user interface unit executes differential updating of a screen at high speed using a virtual document object model. The user interface unit receives JSON data from the server via an application programming interface in a representational state transfer format. The user interface unit stores the received data in a state management library on a client side. When detecting a change in state, the user interface unit redraws only a related screen component. The user interface unit acquires voice waveform data input from a microphone of the terminal. The user interface unit converts the voice waveform data into frequency spectrum data by fast Fourier transform. The user interface unit transmits the frequency spectrum data to a voice recognition module of the server. The server converts the voice data into a text command and returns it to the user interface unit. The user interface unit automatically sets a value in an input form based on the text command. The system executes such advanced cooperation between front-end technology and back-end technology. The system reduces a network communication amount. The system optimizes a memory usage amount of the terminal. The system reduces a user's operation delay to the utmost limit. The system functions extremely effectively in use cases such as a forklift worker in a warehouse checking inventory with a tablet terminal. The system realizes hands-free intuitive system operation.

The alert notification unit has a function of detecting various risks such as a stockout risk, an excess inventory risk, a procurement delay risk, a logistics delay risk, a supply risk, and a quality risk in real time based on risk information and recommended actions output from the demand prediction unit, the procurement optimization unit, and the inventory simulation unit, and immediately notifying them via a terminal of a person in charge, an e-mail, a chat tool, a mobile application, or the like. For example, when a prediction that an inventory of a specific product will become zero in three days is issued, it automatically transmits an alert prompting a person in charge of the purchasing department to place an emergency order. In addition, when a logistics delay occurs, it notifies a person in charge of the logistics department to prompt arrangement of an alternative transportation means. Furthermore, the alert notification unit automatically switches a notification method and a notification destination according to a severity and an urgency of the risk. Specifically, the alert notification unit executes an event-driven rule engine. The alert notification unit asynchronously receives an event message transmitted from each unit via a message broker. The event message includes numerical data indicating a type, an occurrence probability, and a degree of impact of the risk. The alert notification unit analyzes a payload of the received message. The alert notification unit calculates a risk score by calculating a product of the occurrence probability and the degree of impact. The alert notification unit compares the risk score with a plurality of predefined threshold values. The alert notification unit determines the severity as critical when the risk score exceeds a maximum threshold value. The alert notification unit calls an application programming interface of a push notification service provider when the severity is critical. The alert notification unit immediately transmits a push notification to a mobile terminal of the person in charge. The alert notification unit stores the message in a batch processing queue when the severity is low. The alert notification unit aggregates messages at regular time intervals and transmits them as an e-mail. The system executes such dynamic routing and throttling control. The system prevents network congestion due to a spike in notifications. The system levels consumption of system resources. The system brings about a technical effect of preventing oversight of an important alert due to information overload. The system functions extremely effectively in use cases such as 24-hour monitoring operations in a global supply chain. The system dramatically speeds up an initial response to an incident.

The external cooperation unit has a function of performing data cooperation in real time with various external systems and databases such as a POS system, an inventory management system, a logistics management system, an accounting system, an external weather information service, an economic indicator database, and an SNS analysis service. For example, it automatically acquires sales performance data from the POS system, acquires an inventory movement history from the logistics management system, acquires weather data from the external weather information service, and acquires data on the amount of topics regarding products from the SNS analysis service. The external cooperation unit supports various cooperation methods such as API cooperation, file cooperation, batch processing, and streaming processing, and also considers data security and privacy protection. Specifically, the external cooperation unit acquires and manages a secure access token with an external system using an OAuth authentication protocol. The external cooperation unit encrypts a communication path using a transport layer security protocol. The external cooperation unit buffers a payload in a JSON format received from the external system on a memory. The external cooperation unit detects a field corresponding to personal information in the payload. The external cooperation unit anonymizes data by applying an irreversible hash function to the detected field. The external cooperation unit applies a window function to streaming data. The external cooperation unit aggregates data within a certain time frame and transfers it as a micro-batch to the subsequent data integration unit. The external cooperation unit uses a secure file transfer protocol in file cooperation. The external cooperation unit decompresses and parses the received compressed file on-memory. The external cooperation unit automatically executes retry processing using an exponential backoff algorithm when a communication error or a timeout occurs. The system constructs such a robust data cooperation infrastructure. The system prevents a failure of an external system from spreading to the entire system. The system guarantees confidentiality and integrity of data at a cryptographic level. The system functions extremely effectively in use cases such as advanced supply chain finance involving cooperation with a settlement system of a financial institution. The system dramatically improves reliability of inter-enterprise data cooperation.

As described above, the system according to the present embodiment includes a demand prediction unit, a procurement optimization unit, an inventory simulation unit, a data integration unit, a user interface unit, an alert notification unit, and an external cooperation unit, and each unit cooperates to analyze information of the entire supply chain in real time and centrally, optimizes from demand prediction to a procurement plan, inventory management, and risk response in an integrated manner, and can realize resolution of supply chain fragmentation, speeding up of supply and demand adjustment, reduction of an excess inventory and opportunity loss, and construction of a totally optimized supply chain without depending on personal judgment or manual work. Specifically, the system tightly couples these plurality of independent module groups via a high-speed internal bus and a virtual network. The system centrally manages state data shared among the modules on an in-memory database. The system eliminates data inconsistency. The system guarantees atomicity and consistency of transactions. The system reuses an inference result of an artificial intelligence model in each unit. The system reduces redundant calculation processing. The system minimizes latency of the entire system. The system maximizes computing capability of hardware to the limit. The system integrates conventional siloed business system groups into a single intelligent platform. The system reduces data transfer overhead. The system realizes an extremely efficient architecture from a computer science perspective. The system makes it possible to solve a complex real-world problem of supply chain management on a computer at high speed and accurately by accumulating these technical improvements. The system functions extremely effectively in use cases such as company-wide resource optimization in a multinational conglomerate. The system provides a next-generation fundamental technology that fundamentally strengthens corporate competitiveness.

### Implementation Steps

Step 1: Data Collection and Integration First, necessary data from various data sources such as sales performance data, supplier data, logistics data, inventory data, weather data, economic indicator data, SNS trend data, and competitor trend data are centrally collected by the data integration unit on the server, pre-processing such as format conversion, data cleansing, missing value complementation, time-series matching, and data normalization is performed, and the data is stored in a form usable by each unit. For example, sales data acquired from a POS system, inventory data acquired from a logistics management system, and weather data acquired from an external API are matched in time series and converted into a format easy for generative AI to learn. Specifically, the data integration unit receives raw data from a plurality of external servers via asynchronous communication. The data integration unit stores the received raw data in a temporary storage memory. The data integration unit extracts a feature vector from text data using a natural language processing model. The data integration unit executes zero-mean variance normalization on numerical data. The data integration unit executes complementation processing using an autoencoder on missing values. The data integration unit synchronizes a timestamp of each data source to coordinated universal time. The data integration unit combines the synchronized data as a multidimensional tensor. For example, the data integration unit configures the sales performance data as a one-dimensional array. The data integration unit configures the weather data as a two-dimensional matrix. The data integration unit combines these to generate a three-dimensional input tensor. The input tensor has a time axis, a feature amount axis, and a spatial axis. The data integration unit stores the generated input tensor in a distributed database. By this processing, the system avoids the curse of dimensionality of heterogeneous mixed data. The system dramatically improves a learning convergence speed of a subsequent neural network. The system reduces consumption of computing resources required for data pre-processing. The system is applicable to a demand prediction system in a retail industry and a parts procurement system in a manufacturing industry. The data integration unit filters a noise component from the input raw data. The data integration unit executes an outlier detection algorithm. The outlier detection algorithm calculates a Mahalanobis distance. The data integration unit excludes a data point whose calculated distance exceeds a predetermined threshold value. The data integration unit maps the cleansed data to a feature amount space. The data integration unit executes dimensional compression using principal component analysis. The data integration unit generates a compressed feature amount vector. The feature amount vector is optimized as an input to a subsequent generative artificial intelligence model. The data integration unit transmits a completion signal to a control unit after completion of the processing. The control unit receives the completion signal and triggers execution of the next step.

Step 2: Demand Prediction Model Generation The diverse data prepared by the data integration unit is input to the generative AI, and a demand prediction model is automatically generated. The generative AI learns a correlation of a plurality of factors such as past sales performance, weather fluctuations, SNS trends, competitor trends, promotion histories, and logistics delay histories, and constructs a model capable of predicting sudden demand fluctuations and a demand transition at the time of new product introduction with high accuracy. Specific examples of a prompt sentence to be read by the generative AI include “Predict a weekly demand quantity for each product for the next three months based on sales performance data, temperature data, SNS trend data, and competitor trend data for the past three years. In particular, model with an emphasis on demand fluctuations in weeks when the temperature exceeds 30 degrees or weeks when topics rapidly increase on SNS.” and the like. Specifically, the demand prediction unit acquires the three-dimensional input tensor from the data integration unit. The demand prediction unit inputs the input tensor to a composite architecture of a large language model and a time-series prediction model. The composite architecture includes a transformer network provided with a self-attention mechanism. The transformer network extracts a temporal dependency of the input tensor. The demand prediction unit inputs the prompt sentence to a natural language processing model. The natural language processing model converts the prompt sentence into an embedding vector. The demand prediction unit inputs the embedding vector to the transformer network as a conditioning vector. The transformer network outputs a prediction tensor via a multilayer perceptron. The prediction tensor includes an array of floating-point numbers indicating a future demand quantity of each product. For example, the prediction tensor outputs a numerical vector as a demand prediction value of product A for the next week. The prediction tensor outputs a probability distribution as a demand prediction value of product B for the next month. The demand prediction unit calculates a loss function combining a mean square error and a cross-entropy error. The demand prediction unit updates a weight parameter of the network using an error backpropagation method. By this processing, the system models non-linear demand fluctuations with high accuracy. The system realizes an objective prediction that does not depend on human intuition. The system significantly reduces a prediction error compared to conventional methods. The system is applicable to trend prediction in an apparel industry and a waste loss reduction system in a food industry. The demand prediction unit adjusts a hyperparameter of the generated prediction model using Bayesian optimization. The demand prediction unit evaluates generalization performance of the model using a cross-validation method. When an evaluation score does not satisfy a predetermined criterion, the demand prediction unit dynamically changes a learning rate and executes retraining. The demand prediction unit stores a finally optimized weight matrix in a non-volatile memory. The demand prediction unit loads the stored weight matrix in an inference phase. The demand prediction unit transfers an inference result to the subsequent procurement optimization unit.

Step 3: Demand Prediction Execution Using the demand prediction model constructed by the generative AI, a demand quantity of each product in a designated period (for example, the next week, the next month, or a quarterly basis) is predicted in real time. The demand prediction unit simultaneously calculates a reliability and a prediction error of a prediction result, and automatically instructs collection of additional data and model retraining when the reliability is low. For example, for a new product with few similar sales patterns in the past, the generative AI utilizes sales data and market trend data of similar products to improve prediction accuracy. Specifically, the demand prediction unit acquires latest observation data in real time. The demand prediction unit converts the acquired observation data into an input tensor. The demand prediction unit inputs the input tensor to a learned transformer network. The transformer network executes a forward propagation operation. The transformer network generates a prediction tensor from an output layer. The prediction tensor includes a set of scalar values indicating a predicted demand amount of each product. For example, the prediction tensor outputs a numerical value of ten thousand as a demand amount of drinking water for the next week. The prediction tensor outputs a numerical value of five thousand as a demand amount of a winter-limited product for the next month. The demand prediction unit calculates a reliability score together with the prediction tensor. The reliability score is a probability value indicating uncertainty of prediction. The demand prediction unit estimates a variance of prediction using a Monte Carlo dropout method. The demand prediction unit defines a reciprocal of the estimated variance as the reliability score. The demand prediction unit determines whether or not the reliability score falls below a predetermined threshold value. When falling below the threshold value, the demand prediction unit sets an anomaly detection flag. The demand prediction unit transmits an acquisition request for additional data to a data collection unit based on the anomaly detection flag. The demand prediction unit executes fine-tuning of the model using the additional data. By this processing, the system improves adaptability of the model to environmental changes. The system autonomously prevents deterioration of prediction accuracy. The system applies zero-shot learning in demand prediction of a new product. The system calculates a distance in a feature vector space of similar products. The system diverts a sales pattern of an existing product with the closest distance to prediction of the new product. The demand prediction unit writes a final prediction result to a database as structured data. The demand prediction unit provides the prediction result to the subsequent procurement optimization unit and inventory simulation unit.

Step 4: Procurement Optimization Plan Formulation Various parameters such as the future demand prediction value output by the demand prediction unit, a procurement cost for each supplier, a maximum procurable amount, a logistics cost, a lead time, supplier supply stability, a delivery date compliance rate, availability of distributed procurement from a plurality of suppliers, procurement budget constraints, exchange rate fluctuations, raw material price fluctuations, supplier credit risk, and disaster risk are input to the generative AI, and an optimal procurement plan is automatically formulated. The generative AI automatically selects and applies optimization methods such as reinforcement learning, evolutionary algorithms, and a mixed integer programming method, and calculates a procurement plan that simultaneously satisfies a plurality of objective functions such as minimization of procurement cost, dispersion of supply risk, maximization of a delivery date compliance rate, and optimization of an inventory turnover rate. Specific examples of a prompt sentence to be read by the generative AI include “Formulate a procurement plan that minimizes procurement cost, disperses supply risk, and maximizes a delivery date compliance rate in consideration of a demand quantity for the next month output by the demand prediction unit, a procurement cost of each supplier, a maximum procurable amount, a logistics cost, a lead time, supply stability, a delivery date compliance rate, exchange rate fluctuations, raw material price fluctuations, and disaster risk. Distributed procurement from a plurality of suppliers is also allowed.” and the like. Specifically, the procurement optimization unit receives the prediction tensor from the demand prediction unit. The procurement optimization unit acquires constraint condition data of suppliers from an external database. The procurement optimization unit combines these data to generate a state vector. The procurement optimization unit inputs the state vector to a deep reinforcement learning agent. The deep reinforcement learning agent adopts an actor-critic architecture. The actor network outputs an action probability distribution from the state vector. The action probability distribution indicates an allocation ratio of an order quantity to each supplier. For example, the actor network outputs an order ratio of sixty percent to supplier A and forty percent to supplier B. The critic network calculates an expected reward value for a selected action. The procurement optimization unit defines a weighted sum of a reciprocal of the procurement cost and the delivery date compliance rate as a reward function. The procurement optimization unit updates a weight of the network using a proximal policy optimization algorithm. The procurement optimization unit evaluates a plurality of objective functions in a framework of Pareto optimization. The procurement optimization unit searches a solution space using a genetic algorithm. The procurement optimization unit applies crossover and mutation operators to generate next-generation solution candidates. The procurement optimization unit selects an optimal procurement plan vector based on a fitness function. The procurement plan vector includes a combination of an order date, an order destination, an order quantity, and a transportation means. By this processing, the system derives an optimal solution under complex constraint conditions at high speed. The system realizes rational decision-making that does not depend on human rules of thumb. The system mathematically minimizes a fragmentation risk of a supply chain. The system is applicable to parts procurement in a global manufacturing industry and product purchasing in a retail industry. The procurement optimization unit transmits the generated procurement plan vector to the subsequent inventory simulation unit. The procurement optimization unit automatically issues an order API call to an ordering system.

Step 5: Inventory Simulation Execution Various parameters such as the procurement plan by the procurement optimization unit, the demand prediction value by the demand prediction unit, a current inventory quantity, a logistics lead time, a supplier supply delay risk, a demand distribution for each sales channel, an inventory storage cost, a disposal risk, expiration date information, an inventory movement cost, an inter-base inventory movement history, past stockout histories, and excess inventory occurrence histories are input to the generative AI, a future inventory transition is simulated at an arbitrary granularity such as a daily basis, a weekly basis, or a monthly basis, and an occurrence probability of an excess inventory or a stockout risk is quantitatively calculated. Specific examples of a prompt sentence to be read by the generative AI include “Simulate a daily inventory transition for the next month based on a procurement plan output by the procurement optimization unit, a demand prediction value output by the demand prediction unit, a current inventory quantity, a logistics lead time, a supply delay risk, a demand distribution for each sales channel, an inventory storage cost, and expiration date information, issue an alert when a stockout risk increases, and present a recommended action such as discount sales or inventory movement when an excess inventory occurs.” and the like. Specifically, the inventory simulation unit receives the procurement plan vector and the prediction tensor as inputs. The inventory simulation unit initializes current inventory data as a state matrix. The inventory simulation unit calculates a future state transition using a Markov chain Monte Carlo method. The inventory simulation unit models a time-series inventory fluctuation using a recurrent neural network. The recurrent neural network includes a long short-term memory cell. The long short-term memory cell holds a past inventory fluctuation pattern as a hidden state vector. The inventory simulation unit calculates a difference between a warehousing amount and a shipping amount at each time step. The inventory simulation unit adds the calculated difference to the state matrix to predict an inventory amount of the next step. The inventory simulation unit outputs an inventory transition tensor as a simulation result. The inventory transition tensor is a three-dimensional array including a predicted inventory amount at each base, each product, and each date. For example, the inventory transition tensor outputs a numerical value of fifty as an inventory amount of product Y at base X ten days later. The inventory simulation unit calculates a probability that the predicted inventory amount falls below a safety stock threshold value. The inventory simulation unit calculates a probability that the predicted inventory amount exceeds a maximum storage capacity. The inventory simulation unit digitizes these probabilities as a risk score. By this processing, the system detects future inventory depletion and excess inventory in advance. The system realizes a precise simulation considering constraints of a physical storage space. The system optimizes a trade-off between an inventory maintenance cost and an opportunity loss due to a stockout. The system is applicable to inventory management of fresh food in a food supermarket and warehouse management of electronic parts. When the calculated risk score exceeds a predetermined criterion, the inventory simulation unit generates a recommended action vector. The recommended action vector includes an inter-base movement instruction and an order cancellation instruction. The inventory simulation unit transfers the simulation result and the recommended action vector to a subsequent risk detection and alert notification unit.

Step 6: Risk Detection and Alert Notification Based on various risk information such as a stockout risk, an excess inventory risk, a procurement delay risk, a logistics delay risk, a supply risk, and a quality risk calculated by the inventory simulation unit, an alert notification unit immediately notifies via a terminal of a person in charge, an e-mail, a chat tool, a mobile application, or the like. For example, when a prediction that an inventory of a specific product will become zero three days later is issued, an alert prompting an emergency order is automatically transmitted to a person in charge of a purchasing department. Specifically, the alert notification unit receives the risk score and the recommended action vector from the inventory simulation unit. The alert notification unit compares the received risk score with a plurality of threshold values. The alert notification unit determines a risk level based on a comparison result. The alert notification unit classifies a root cause of a risk using a decision tree algorithm. The alert notification unit specifies a user group to be notified based on a classification result. The alert notification unit dynamically generates an alert message text using a natural language generation model. The natural language generation model adopts a transformer decoder architecture. The alert notification unit inputs a type of risk, a predicted occurrence date and time, a target product code, and a recommended action as a prompt. The natural language generation model outputs a text character string in a format easy for a human to understand. For example, the natural language generation model outputs a warning sentence that a probability that an inventory of product Z will be depleted 72 hours later is ninety-five percent. The natural language generation model outputs a proposal sentence recommending emergency procurement from an alternative supplier. The alert notification unit encapsulates the generated text character string into a payload in a JSON format. The alert notification unit transmits the payload to an external messaging server via a RESTful API. The alert notification unit records a transmission history in a log database. By this processing, the system prevents a potential supply chain failure in advance. The system substitutes for human monitoring work and eliminates a delay in response. The system realizes appropriate escalation according to importance of information. The system is applicable to parts management for preventing a stop of a manufacturing line and a stockout prevention system in a retail store. The alert notification unit monitors a response signal from a user. When there is no response within a predetermined time, the alert notification unit executes re-notification to a higher-level administrator. The alert notification unit accumulates a response history of the user as retraining data of a machine learning model. The alert notification unit continuously improves accuracy and timing of an alert using the accumulated data.

Step 7: Decision-Making Support by User Interface The user interface unit visualizes results of demand prediction, a procurement plan, and inventory simulation, a risk alert, a recommended action, and the like in a dashboard or report format, and enables a person in charge of a purchasing department, a logistics department, and a business department to intuitively grasp a situation and input a new sales plan, promotion information, new addition of a supplier, a logistics route change, an inventory movement instruction, an emergency order instruction, and the like as necessary. These input information are reflected in the generative AI on the server in real time, and are immediately reflected in each subsequent step. Specifically, the user interface unit is implemented as a single-page application operating on a web browser. The user interface unit receives a real-time data stream from a back-end server via WebSocket communication. The user interface unit converts the received multidimensional tensor data into a two-dimensional graphical representation. The user interface unit draws a time-series line graph and a heat map using a data visualization library. The user interface unit captures a mouse click and a keyboard input from a user with an event listener. The user interface unit serializes an input parameter change request into a JSON object. The user interface unit transmits the serialized data to the server. A control unit on the server reconstructs an input tensor based on the received change request. The control unit re-inputs the reconstructed input tensor to each optimization module. Each optimization module re-executes a forward propagation operation based on the changed condition. For example, when the user performs an operation of extending a promotion period, the user interface unit transmits the period information to the server as a numerical vector. The server re-executes the demand prediction model and generates a new prediction tensor. The user interface unit redraws a recalculated result on a screen with a delay in milliseconds. By this processing, the system constructs a cooperative decision-making process between a human and artificial intelligence. The system makes an inference process of artificial intelligence, which is easy to become a black box, transparent. The system maximizes responsiveness of the system to dynamic environmental changes to the limit. The system is applicable to a dashboard for management and an operation screen for a person in charge on site. The user interface unit records an operation history of the user as session data. The user interface unit analyzes the operation history to specify a frequently used function. The user interface unit optimizes an access route of the specified function. The user interface unit dynamically generates a screen layout for reducing a cognitive load of the user.

### Specific Use Case

For example, assume a case where supply chain optimization is implemented during a period of sudden demand increase in summer in a business entity that sells beverage products at a plurality of bases nationwide. First, as sales performance data, weekly sales quantities for the past three years for each base, sales for each sales channel, campaign implementation histories, and return and cancellation data are collected. As supplier data, supplier supply capacities, procurement costs, maximum procurable amounts, delivery date compliance rates, past supply delay histories, and quality defect occurrence rates of each supplier are acquired. As logistics data, transport lead times of each product, inventory movement histories for each logistics base, transport costs, logistics delay occurrence histories, and transport obstacle information due to weather and disasters are acquired. As inventory data, inventory quantities for each base, inventory turnover rates, expiration date information, disposal histories, storage costs, and inventory movement histories are acquired. Furthermore, as external data, temperature transition data from a weather information service, topic volume data of the corresponding product from an SNS analysis service, economic indicator data, and competitor trend data are acquired. Specifically, the present system arranges a distributed data collection agent at each base. The data collection agent operates on an edge computing device. The data collection agent periodically extracts data from a local database using an SQL query. The data collection agent encrypts the extracted data and transmits it to a central server. The central server accumulates the received data in a data lake. The central server issues an HTTP request to an API endpoint of the weather information service. The central server acquires the temperature transition data as a time-series floating-point array. The central server analyzes a text stream of SNS using a natural language processing model. The natural language processing model extracts mentions regarding a specific beverage product and assigns a sentiment analysis score. The central server aggregates the sentiment analysis score as a topic volume vector. The central server combines these heterogeneous data with a common timestamp. For example, the central server configures the sales quantity as a one-dimensional tensor. The central server configures the temperature transition data as another one-dimensional tensor. The central server concatenates these to generate a multidimensional feature matrix. By this processing, the present system integrates siloed information into a single calculation space. The present system constructs a foundation for a subsequent machine learning algorithm to discover hidden correlations of the data. The present system minimizes latency of data collection and ensures real-time performance. The present system is applicable to supply chain management of consumer goods with strong seasonality and a special demand prediction system during events. The central server applies a hash function to the collected data to verify data integrity. The central server executes an anomaly detection algorithm to remove noise due to sensor failures and input errors. The central server loads the cleansed data into a high-speed in-memory database. The central server transmits a data preparation completion signal to the subsequent demand prediction unit.

A data integration unit aligns these diverse data in chronological order, performs preprocessing such as missing value imputation, anomaly detection, and data normalization, and converts them into a format learnable by the generative AI. The demand prediction unit gives the generative AI a prompt sentence such as, for example, “Predict weekly demand quantities for each base and each product for the next three months based on weekly sales performance data of beverage products for the past three years, temperature transition data, SNS trend data, competitor trend data, and campaign histories. In particular, model with an emphasis on demand fluctuations in weeks when the temperature exceeds 30 degrees or weeks when topics rapidly increase on SNS.”, and causes it to generate a demand prediction model. The generative AI learns a correlation of a plurality of factors such as an influence of a temperature rise and an increase in SNS topic volume on a demand increase of a specific product, a sales increase rate during campaign implementation, and demand fluctuations at the time of competitor new product introduction, and predicts the demand of each base and each product with high accuracy. Specifically, the data integration unit executes an interpolation algorithm for unifying sampling rates of time-series data. The data integration unit estimates missing values using spline interpolation. The data integration unit generates a multidimensional feature matrix. The demand prediction unit inputs the multidimensional feature matrix to a transformer-based neural network. The neural network includes an encoder layer and a decoder layer. The encoder layer extracts a hidden state representation from the multidimensional feature matrix. The demand prediction unit tokenizes the prompt sentence and converts it into an embedding vector. The demand prediction unit inputs the embedding vector to the decoder layer via a cross-attention mechanism. The decoder layer integrates the hidden state representation and the embedding vector and outputs a prediction tensor. The prediction tensor is a numerical matrix indicating a future demand amount of each base and each product. For example, the prediction tensor outputs a numerical value of 50,000 bottles as the demand amount of carbonated beverages at the Tokyo base for the next week. The prediction tensor outputs a numerical value of 100,000 bottles as the demand amount of sports beverages at the Osaka base for the next month. The demand prediction unit calculates a mean absolute error as a loss function. The demand prediction unit optimizes weights of the network using a gradient descent method. By this processing, the present system models a complex nonlinear relationship between unstructured data such as temperature and SNS topic volume and structured data such as sales performance. The present system captures signs of minute demand fluctuations that cannot be captured by human rules of thumb. The present system dramatically improves prediction accuracy and suppresses overproduction. The present system is applicable to production planning of beverage manufacturers and automated ordering systems of convenience stores. The demand prediction unit applies a smoothing filter to the generated prediction tensor. The demand prediction unit removes extreme spike noise. The demand prediction unit stores final prediction data in a database. The demand prediction unit transfers the prediction data to the subsequent procurement optimization unit.

The procurement optimization unit inputs the future demand prediction value output by the demand prediction unit, the procurement cost of each supplier, the maximum procurable amount, the logistics cost, the lead time, supply stability, the delivery date compliance rate, exchange rate fluctuations, raw material price fluctuations, disaster risks, and the like to the generative AI, gives a prompt sentence such as “Formulate a procurement plan that minimizes the procurement cost, disperses supply risks, and maximizes the delivery date compliance rate in consideration of the demand quantity for the next month output by the demand prediction unit, the procurement cost of each supplier, the maximum procurable amount, the logistics cost, the lead time, the supply stability, the delivery date compliance rate, the exchange rate fluctuations, the raw material price fluctuations, and the disaster risks. Distributed procurement from a plurality of suppliers is also allowed.”, and automatically formulates an optimal procurement plan. The generative AI calculates an order quantity and an order timing that balance the procurement cost and the supply risk by combining, for example, simultaneous ordering from a plurality of suppliers, utilization of emergency transport means, and lead time reduction measures in a week when a sudden demand increase is predicted. Specifically, the procurement optimization unit acquires the prediction tensor from the demand prediction unit. The procurement optimization unit acquires time-series vectors of exchange rates and raw material prices from an external market data feed. The procurement optimization unit combines these data to construct a high-dimensional state space vector. The procurement optimization unit inputs the state space vector to a deep Q-network. The deep Q-network is composed of a plurality of fully connected layers. The deep Q-network outputs an expected Q-value for each action. The action space is defined as a combination of an order destination, an order quantity, and a transport mode. For example, the deep Q-network outputs a high score as a Q-value of an action of ordering 10,000 pieces from supplier C by normal transport. The deep Q-network outputs a medium score as a Q-value of an action of ordering 5,000 pieces from supplier D by airmail. The procurement optimization unit selects an optimal action using an epsilon-greedy method. The procurement optimization unit generates a procurement plan matrix based on the selected action. The procurement plan matrix includes a date, a supplier ID, a product ID, a quantity, and a transport means code. The procurement optimization unit verifies whether the procurement plan matrix satisfies budget constraints and the maximum procurable amount using a constraint satisfaction problem solver. By this processing, the present system instantaneously searches for an optimal procurement route from among a huge number of combinations. The present system eliminates dependence on a supplier that becomes a single point of failure and improves resilience of the supply chain. The present system derives a Pareto optimal solution of the procurement cost and the risk. The present system is applicable to global parts procurement in the automobile industry and semiconductor purchasing systems of electronic device manufacturers. The procurement optimization unit saves the procurement plan matrix that has passed the verification as confirmed data. The procurement optimization unit transmits the confirmed procurement plan matrix to an ERP system. The procurement optimization unit automatically transmits electronic order data to each supplier via the ERP system. The procurement optimization unit notifies the inventory simulation unit of an order completion status.

The inventory simulation unit inputs the procurement plan by the procurement optimization unit, the demand prediction value by the demand prediction unit, the current inventory quantity, the logistics lead time, the supply delay risk, the demand distribution for each sales channel, the inventory storage cost, expiration date information, inventory movement costs, inter-base inventory movement histories, past stockout occurrence histories, excess inventory occurrence histories, and the like to the generative AI, gives a prompt sentence such as “Simulate daily inventory transitions for the next month based on the procurement plan output by the procurement optimization unit, the demand prediction value output by the demand prediction unit, the current inventory quantity, the logistics lead time, the supply delay risk, the demand distribution for each sales channel, the inventory storage cost, and the expiration date information, issue an alert when a stockout risk increases, and present a recommended action such as discount sales or inventory movement when an excess inventory occurs.”, and simulates a future inventory transition. The generative AI simultaneously considers the stockout risk during the period of sudden demand increase, a disposal risk due to expiration, optimization of inventory relocation between bases, and the like, and outputs specific actions for preventing stockouts and reducing disposal. Specifically, the inventory simulation unit loads the procurement plan matrix and the prediction tensor onto a memory. The inventory simulation unit sets current inventory data as an initial state vector. The inventory simulation unit activates a discrete event simulation engine. The simulation engine calculates an inventory flow between respective nodes using a probabilistic graphical model. The inventory simulation unit processes a warehousing event and a shipping event at each time step. The inventory simulation unit models the supply delay risk as a random variable following a Poisson distribution. The inventory simulation unit executes 10,000 independent simulation paths using a Monte Carlo method. The inventory simulation unit aggregates results of each path to generate a probability density function of the inventory transition. The inventory simulation unit calculates an expected inventory amount and a confidence interval at each date from the probability density function. For example, the inventory simulation unit outputs a result that a probability that the inventory amount of a specific product at base A after 10 days becomes zero is 15 percent. The inventory simulation unit outputs a result that a probability that the inventory of a specific product at base B after 20 days exceeds a storage upper limit is 30 percent. The inventory simulation unit generates a risk score vector based on these probabilities. The inventory simulation unit generates a recommended action vector for reducing the risk using a reinforcement learning model. The recommended action vector includes an inventory movement instruction from base A to base B and a discount rate setting for a specific product. By this processing, the present system quantitatively evaluates a future inventory state accompanied by uncertainty. The present system mathematically minimizes disposal loss due to expiration. The present system dynamically resolves uneven distribution of inventory between bases. The present system is applicable to an appropriate placement system for pharmaceuticals and an inter-store inventory movement system in the apparel industry. The inventory simulation unit writes the generated risk score vector and recommended action vector into the database. The inventory simulation unit transfers these data to a user interface unit and an alert notification unit.

The user interface unit visualizes results of the demand prediction, the procurement plan, and the inventory simulation, risk alerts, recommended actions, and the like in a dashboard or report format, and enables persons in charge of a purchasing department, a logistics department, and a business department to intuitively grasp the situation and input a new sales plan, promotion information, new addition of a supplier, logistics route change, an inventory movement instruction, an emergency order instruction, and the like as necessary. The alert notification unit immediately notifies via a terminal of the person in charge, an e-mail, a chat tool, a mobile application, or the like when the stockout risk or the excess inventory risk increases. Specifically, the user interface unit generates a dynamic web page constructed using a front-end framework. The user interface unit receives simulation result data in JSON format from the server. The user interface unit parses the received data and updates a virtual DOM tree. The user interface unit draws a complex supply chain situation using a three-dimensional scatter plot or a network graph. The user interface unit receives a parameter change request via an input form from a user. The user interface unit analyzes the input text data with a natural language processing model and converts it into a structured command vector. The user interface unit transmits the command vector to a back-end control unit. The alert notification unit operates as a daemon process resident in the back end. The alert notification unit periodically polls the risk score vector. The alert notification unit detects that the risk score has exceeded a set threshold value. The alert notification unit calls an API of a push notification service provider. The alert notification unit transmits an encrypted payload to a smartphone terminal of a target user. For example, the alert notification unit transmits an interactive notification including a message prompting an emergency order and an approval button. The alert notification unit receives an event in which the user taps the approval button. The alert notification unit executes an automatic ordering script triggered by the event. By this processing, the present system provides a seamless interface between human and machine. The present system shortens a time lag from decision-making to execution to the utmost limit. The present system prevents a serious incident due to oversight of information. The present system is applicable to a control system of a large-scale logistics center and global supply chain management of a multinational corporation. The user interface unit records an operation log of the user in the database together with a timestamp. The user interface unit continuously evaluates usability of the interface using the operation log. The alert notification unit tracks a read state of the notification. The alert notification unit executes re-notification using an alternative communication channel when an unread state continues.

By such a use case, the system of the present invention can optimize the entire supply chain in real time and centrally even during a period of sudden demand increase or external environment changes, minimize risks such as stockouts, excess inventory, opportunity loss, and disposal loss, and realize totally optimized supply chain operation. Specifically, the present system executes a pipeline architecture integrating a plurality of neural network models. The present system asynchronously passes multidimensional tensor data between respective modules. The present system updates inference results of each model in a chained manner in response to fluctuations in input data. The present system captures the entire supply chain as one huge graph structure rather than local optimization. The present system calculates interactions between nodes using a graph neural network. The present system sets a linear combination of overall profit maximization and risk minimization as an objective function. The present system optimizes the objective function using a gradient descent method. For example, the present system detects a logistics delay due to weather deterioration at a certain base. The present system immediately automatically generates a search for an alternative route and an inventory compensation plan from another base. The present system calculates cost increase/decrease accompanying these changes in real time. The present system autonomously executes a countermeasure with the highest expected value. By this processing, the present system adapts to dynamic and complex environmental changes that cannot be handled by a static rule-based system. The present system simultaneously processes variables on a scale exceeding human cognitive limits. The present system dramatically improves operational efficiency of the supply chain. The present system derives a highly accurate optimal solution while suppressing consumption of calculation resources. The present system is applicable as a core system of all industries such as manufacturing, retail, and logistics. The present system accumulates execution results as learning data through a feedback loop. The present system continuously updates weights of the model using an online learning algorithm. The present system self-evolves prediction accuracy and optimization capability of the system over time. The present system further expands generalization performance of the model by newly adding data feeds of external economic indicators and geopolitical risks. The present system automatically generates a final optimization result as a report for management and supports strategic decision-making.

### Application Example 1

The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying out the Present Invention

Embodiments of the present invention will be described more specifically and in detail. The present invention is configured with a warehousing and shipping optimization unit, a personnel allocation optimization unit, a transport robot operation planning unit, and a delivery vehicle loading planning unit in a logistics center as a core, each of these units is mainly executed on a server, and a terminal is configured to play roles such as a user interface for an on-site person in charge or an administrator, data input/output, result visualization, and alert notification. Specifically, the present system includes a distributed processing cluster constructed on a cloud computing environment. The distributed processing cluster includes a plurality of calculation nodes and graphics processing units. The server adopts a microservices architecture. The server executes each optimization unit as an independent container. The server automatically performs scaling according to a load using a container orchestration tool. The server controls asynchronous communication between respective containers via a message queuing system. The terminal is configured as a tablet terminal or a wearable device. The terminal connects to the server using a secure communication protocol. The terminal receives a data stream in JSON format transmitted from the server. The terminal caches the received data in a local memory. The terminal renders the user interface using the cached data. For example, the terminal draws a current position of a transport robot on a two-dimensional map in real time. The terminal sorts and displays a task list of workers in order of priority. By this processing, the present system processes huge data traffic in a large-scale logistics center without delay. The present system eliminates a single point of failure and realizes high availability. The present system provides intuitive and immediate instructions to on-site workers. The present system is applicable to a huge warehouse facility and a network system that integrally manages a plurality of logistics bases. The server writes plan data generated by each optimization unit into an integrated database. The server performs transaction management of the database and guarantees data consistency. The server periodically saves a backup of data in a storage in another region. The server executes a monitoring agent that monitors an operation status of the entire system. The monitoring agent immediately transmits an alert to the administrator when detecting an abnormality.

First, the warehousing and shipping optimization unit integrates various data sources such as scheduled receiving data, scheduled shipping data, inventory data, weather data, traffic condition data, economic indicator data, SNS trend data, and competitor trend data in the logistics center on the server, and inputs them to the generative AI. For example, the scheduled receiving data includes scheduled delivery dates, products, and quantities from each supplier, the scheduled shipping data includes scheduled shipping dates, products, and quantities to each customer, the inventory data includes current inventory quantities and locations for each product, the weather data includes rainfall, snowfall, temperature, and typhoon information, the traffic condition data includes traffic congestion, accident, and road closure information, the economic indicator data includes consumption trends and price indices, the SNS trend data includes topic volumes of specific products, and the competitor trend data includes new release information and price revision information of competitor products. Based on these data, the generative AI learns a correlation of a plurality of factors such as past shipping performance, seasonal fluctuations, demand fluctuations during campaigns, shipping decrease during bad weather, demand fluctuations at the time of competitor new product introduction, and sudden demand increase at the time of sudden topic increase on SNS, and predicts shipping demand of each product in an arbitrary period such as the next week or the next month with high accuracy. Furthermore, in order to prevent a stockout or an excess inventory, it automatically generates a warehousing and shipping plan that optimizes a balance of receiving, shipping, and inventory using an optimization method such as a linear programming method, reinforcement learning, or an evolutionary algorithm, and minimizes occurrence of a stockout or an excess inventory while maximizing an inventory turnover rate. For example, when a sudden demand increase of a specific product is predicted, it is possible to propose measures such as moving up receiving, delaying receiving for a product with excess inventory, or promoting shipping. Furthermore, inventory movement between a plurality of bases in the logistics center is also set as an optimization target, and for example, when inventory is excessive at base A and inventory is insufficient at base B, the generative AI automatically generates an optimal inventory movement plan and realizes total optimization. Specifically, the warehousing and shipping optimization unit converts the collected diverse data into a multidimensional input tensor. The warehousing and shipping optimization unit inputs the input tensor to a recurrent neural network for time-series prediction. The recurrent neural network learns long-term dependencies using a gated recurrent unit. The recurrent neural network outputs a prediction vector indicating future shipping demand of each product. For example, the prediction vector outputs a numerical value that a shipping amount of product P for the next week is 5,000 pieces. The prediction vector outputs a numerical value that a shipping amount of product Q for the next month is 20,000 pieces. The warehousing and shipping optimization unit combines the prediction vector and current inventory data to define a state space. The warehousing and shipping optimization unit inputs the state space to a deep reinforcement learning model. The deep reinforcement learning model learns an optimal action policy based on a Markov decision process. The deep reinforcement learning model outputs an adjustment instruction for receiving timing and receiving amount of each product as an action. The warehousing and shipping optimization unit sets a reward function that minimizes a sum of an inventory maintenance cost and a stockout penalty. The warehousing and shipping optimization unit updates parameters of the model using a policy gradient method. The warehousing and shipping optimization unit formulates inventory movement between a plurality of bases as a graph optimization problem. The warehousing and shipping optimization unit calculates an optimal inventory movement route and movement amount between bases using a minimum cost flow algorithm. By this processing, the present system dynamically optimizes a warehousing and shipping schedule under complex constraint conditions. The present system formulates a precise plan considering limits of physical storage space in a warehouse. The present system prevents deterioration of cash flow due to excess inventory. The present system is applicable to a fulfillment center of electronic commerce and a parts supply center of a manufacturing industry. The warehousing and shipping optimization unit outputs the generated warehousing and shipping plan and inventory movement plan as structured data. The warehousing and shipping optimization unit transmits these plan data to the subsequent personnel allocation optimization unit and transport robot operation planning unit.

The personnel allocation optimization unit integrates various parameters such as worker shift data, skill information, a health condition, a congestion status of a work area, a priority and urgency of each work task, past work performance of workers, productivity of each worker, desired shifts and leave applications of workers, age and physical strength of workers, and qualifications and licenses of workers on the server, and inputs them to the generative AI. For example, the worker shift data includes working hours, break times, and overtime availability, the skill information includes work experience and qualifications such as picking, packing, loading, and sorting, the health condition includes physical condition declarations and past absence histories, the congestion status of the work area includes worker density and workload for each area, the priority of the work task includes shipping deadline times and emergency shipping instructions, the past work performance includes the number of picking cases and error occurrence rates of each worker, the productivity includes the number of completed works per unit time, the desired shifts and leave applications include desired working days and desired leave days of workers, the age and physical strength include load distribution for elderly workers and young workers, and the qualifications and licenses include allocation of forklift license holders. Based on these pieces of information, the generative AI automatically generates a personnel allocation plan in real time that simultaneously realizes leveling of workload, optimization of personnel costs, maximization of work efficiency, improvement of work quality, and improvement of worker satisfaction, for example, by allocating many experienced workers during a time zone when picking work is concentrated, additionally introducing part-time workers at a timing when packing work increases, allocating light-load work to workers in poor physical condition, dispersedly allocating workers to congested areas, preferentially allocating license holders to forklift work, maximally considering desired shifts and leave requests of workers, and allocating double checks to workers who have made many mistakes in the past. Specifically, the personnel allocation optimization unit encodes attribute data of workers and task requirement data as feature vectors. The personnel allocation optimization unit combines these feature vectors as a matrix. The personnel allocation optimization unit inputs the matrix to a graph neural network. The graph neural network models workers as nodes and suitability with tasks as edge weights. The graph neural network executes a message passing algorithm to update a hidden state of each node. The personnel allocation optimization unit inputs the updated hidden state to a multilayer perceptron. The multilayer perceptron outputs a score matrix indicating an allocation probability of each worker and each task. For example, the score matrix outputs 95 percent as a probability of allocating worker A to forklift work. The score matrix outputs 80 percent as a probability of allocating worker B to picking work. The personnel allocation optimization unit calculates an optimal allocation combination from the score matrix using a Hungarian algorithm. The personnel allocation optimization unit sets limits on continuous working hours and securing of break times based on the Labor Standards Act as hard constraints. The personnel allocation optimization unit verifies whether an allocation result satisfies all hard constraints using a constraint satisfaction solver. By this processing, the present system realizes detailed task allocation considering abilities and states of individual workers. The present system prevents load concentration on a specific worker and improves a working environment. The present system maximizes overall work throughput by allocation according to proficiency. The present system is applicable to personnel management in a large-scale logistics warehouse and an assembly line of a manufacturing plant. The personnel allocation optimization unit outputs the confirmed personnel allocation plan as data in JSON format. The personnel allocation optimization unit transmits the data to a mobile terminal of each worker as a push notification. The personnel allocation optimization unit monitors work progress in real time, and dynamically recalculates allocation when a delay occurs.

The transport robot operation planning unit integrates various parameters such as a current position of each robot, an operation status, a remaining battery level, a transport capacity for each robot, a congestion degree of the work area, a priority and urgency of each work task, past operation performance of robots, failure histories of robots, maintenance schedules of robots, operation time limits of robots, and loadable weights and transport speeds of robots on the server, and inputs them to the generative AI. For example, the current position of the transport robot includes location mapping, the operation status includes operating, waiting, charging, and malfunctioning, the remaining battery level includes percentage display, the transport capacity includes maximum load weight and maximum transport distance, the congestion degree of the work area includes robot density and obstacle information for each area, the priority of the work task includes emergency shipping and transport of expensive products, the past operation performance includes the number of transport cases and operation rates of each robot, the failure history includes the number of past failure occurrences and failure causes, the maintenance schedule includes the next scheduled inspection date, the operation time limit includes continuous operation times and break times, and the loadable weight and transport speed include spec differences for each robot. Based on these pieces of information, the generative AI automatically generates an operation plan that simultaneously realizes optimization of robot operation efficiency and battery consumption, improvement of safety in the work area, reduction of robot failure risks, and improvement of maintenance efficiency, for example, by preferentially allocating a robot with a sufficient remaining battery level to long-distance transport, allocating a robot whose current location is close to a picking area, restricting entry of robots into a congested area, allocating a short-distance task to a robot with a high failure risk, excluding a robot scheduled for maintenance from the operation plan, allocating a large robot to a task with a large load weight, and allocating an emergency task to a robot with a fast transport speed. Specifically, the transport robot operation planning unit receives telemetry data of each robot in real time. The transport robot operation planning unit formats the received data as a state vector. The transport robot operation planning unit expresses spatial information in the warehouse as a two-dimensional grid map tensor. The transport robot operation planning unit inputs the state vector and the grid map tensor to a convolutional neural network. The convolutional neural network extracts spatial features and calculates a passage cost of each grid. The transport robot operation planning unit executes a multi-agent reinforcement learning algorithm. The algorithm treats each robot as an independent agent. The algorithm learns a policy that minimizes arrival time to a destination while avoiding collisions between agents. The transport robot operation planning unit outputs a coordinate sequence of a movement route and a task allocation list for each robot. For example, the transport robot operation planning unit outputs a movement route from coordinate A to coordinate B and a transport task of product C for robot X. The transport robot operation planning unit outputs a return command to a charging station for robot Y. The transport robot operation planning unit predicts power consumption in each route using a battery consumption model. The transport robot operation planning unit excludes a route in which predicted power consumption exceeds a current remaining amount from a search space. By this processing, the present system constructs an environment in which a large number of robots cooperatively operate as swarm control. The present system mathematically avoids deadlocks and route congestion. The present system increases an operation rate of robots to the utmost limit and improves throughput of the logistics center. The present system is applicable to an automated huge warehouse and an automated guided vehicle control system in a factory. The transport robot operation planning unit transmits the generated route data to a control unit of each robot via wireless communication. The transport robot operation planning unit receives a completion signal from the robot and updates a status of the task. The transport robot operation planning unit receives an alert from a robot that has detected an obstacle, and immediately recalculates an alternative route.

The delivery vehicle loading planning unit integrates various parameters such as a loadable amount of each vehicle, a current location, an operable time, a delivery destination route, traffic congestion information, a delivery delay risk due to weather, a shipping demand prediction, a driver's shift and break time, a remaining fuel level and a remaining battery level of the vehicle, a maintenance schedule of the vehicle, a delivery time designation for each delivery destination, an acceptable time zone of the delivery destination, and unloading facility information of the delivery destination on a server, and inputs them to generative AI. For example, the loadable amount includes a maximum loading weight and volume for each vehicle, the current location includes GPS information, the operable time includes a driver's work shift and legal binding time, the delivery destination route includes an optimal route for a plurality of delivery destinations, the traffic congestion information includes a real-time congestion map, the weather information includes rainfall, snowfall, and typhoon approach information, the shipping demand prediction includes a shipping quantity to each delivery destination, the driver's shift and break time include legal break and replacement requirements, the remaining fuel level and the remaining battery level include availability of long-distance delivery, the maintenance schedule includes a next scheduled inspection date, the delivery time designation includes an acceptable time zone for each delivery destination, and the unloading facility information includes presence or absence of a forklift and presence or absence of unloading personnel. Based on this information, the generative AI automatically generates a loading plan for simultaneously realizing maximization of loading efficiency of the vehicle and minimization of the delivery delay risk, optimization of labor management of the driver, improvement of delivery quality, and reduction of delivery cost, for example, by proposing mixed loading of a plurality of products to maximize the loading efficiency, adjusting a departure time and a delivery order to avoid a delay risk due to traffic congestion or bad weather, replacing the vehicle in consideration of the driver's binding time, allocating a nearest vehicle when an emergency shipment occurs, preferentially allocating an early time zone to a delivery destination with a strict delivery time designation, and additionally arranging personnel for a delivery destination without unloading facilities. Specifically, the delivery vehicle loading planning unit constructs vehicle data and delivery destination data as a multidimensional vector. The delivery vehicle loading planning unit defines a complex optimization problem combining a three-dimensional bin packing problem and a traveling salesperson problem. The delivery vehicle loading planning unit executes a hybrid model fusing an evolutionary algorithm and deep learning to solve the complex optimization problem. The hybrid model generates an initial solution of a delivery order using a pointer network. The delivery vehicle loading planning unit sets the generated initial solution as an initial population of the evolutionary algorithm. The delivery vehicle loading planning unit applies crossover and mutation operators to expand a search space of the solution. The delivery vehicle loading planning unit calculates a fitness of each solution. The fitness function includes minimization of a total travel distance, maximization of a loading rate, and a violation penalty of a time frame constraint. The delivery vehicle loading planning unit outputs three-dimensional coordinate data indicating an optimal loading arrangement and a node sequence of a delivery route. For example, the delivery vehicle loading planning unit outputs arrangement coordinates of a product package on a loading platform of a vehicle Z in millimeters. The delivery vehicle loading planning unit outputs an optimal patrol order and an estimated arrival time of five delivery destinations visited by the vehicle Z. The delivery vehicle loading planning unit acquires real-time traffic congestion data from an external map information API. The delivery vehicle loading planning unit reflects the congestion data as a weight of a graph, and recalculates a shortest path between nodes using Dijkstra's algorithm. By this processing, the system derives an optimal solution satisfying a physical space constraint and a temporal constraint simultaneously at high speed. The system reduces empty running of a truck and reduces carbon dioxide emissions. The system prevents overwork of the driver and complies with compliance. The system is applicable to route optimization of home delivery and a route delivery system of a convenience store. The delivery vehicle loading planning unit renders the generated loading plan as three-dimensional graphics. The delivery vehicle loading planning unit transmits the rendered image to a terminal of a loading person in charge in a warehouse. The delivery vehicle loading planning unit transmits delivery route data to a navigation terminal of the driver.

Furthermore, the system of the present invention automatically updates all plans and predictions in real time, and even when a sudden event such as sudden bad weather, traffic congestion, poor physical condition of a worker, a failure of a robot, or an emergency shipping instruction occurs, the generative AI can immediately take in new data, recalculate a warehousing and shipping plan, a personnel allocation plan, a robot operation plan, and a vehicle loading plan, and present the latest instruction or alert to a terminal of a site person in charge or an administrator. For example, when traffic is blocked due to sudden heavy snow, the generative AI reconstructs a delivery route and presents a new loading plan for minimizing a delivery delay risk. For example, when a sudden absence of a worker occurs, the personnel allocation is automatically readjusted in consideration of shifts and skills of other workers. For example, when a remaining battery level of a robot suddenly decreases, a charging schedule is automatically adjusted, and a task is allocated to another robot. For example, when demand for a specific product suddenly increases on SNS, a demand prediction is immediately corrected, and all receiving, shipping, inventory, and delivery plans are automatically re-optimized. For example, when an unloading facility breaks down at a delivery destination, arrangement of additional personnel or reallocation to another vehicle is automatically proposed. Specifically, the system adopts an event-driven architecture. The system continuously receives streaming data from various sensors and external APIs. The system executes a complex event processing engine. The complex event processing engine detects a specific pattern from the received data stream. The complex event processing engine generates an interrupt signal when detecting an abnormal pattern. Upon receiving the interrupt signal, the system pauses batch processing currently being executed. The system issues a recalculation command to an affected optimization module. The system overwrites a state vector on an in-memory database with the latest observation value. Each optimization module re-executes a forward propagation operation using the updated state vector as an input. For example, the system receives an error code indicating a failure of a robot. The system deletes the robot from a list of operable nodes. The system re-executes a graph neural network and outputs a task reallocation matrix to remaining robots. The system extracts the recalculated result as difference data. The system transmits the difference data to a related terminal by push communication. By this processing, the system prevents obsolescence of a static plan and always maintains a state synchronized with the real world. The system realizes a self-healing capability of the system against an unexpected failure. The system executes autonomous recovery without human intervention. The system is applicable to a mission-critical logistics infrastructure and an emergency relief supply transport system in the event of a disaster. The system uses a cache of a calculation graph in order to suppress a time required for recalculation to a millisecond order. The system skips calculation of an unaffected part and locally re-evaluates only a changed part. The system stores an occurred sudden event and a response history of the system thereto as a log. The system utilizes the log as offline learning data of a reinforcement learning model, and further improves a response speed to a similar event in the future.

In addition, on the terminal side, a site person in charge or an administrator can browse results of the warehousing and shipping plan, the personnel allocation plan, the robot operation plan, and the vehicle loading plan executed on the server in a dashboard or report format, and a scheduled warehousing and shipping graph of each product, a worker allocation table, a robot operation schedule, a vehicle loading plan table, a risk alert list, a recommended action list, and the like are visualized. The person in charge can also input information such as a new receiving schedule, a shipping instruction, a worker's shift request, a robot maintenance schedule, an additional arrangement of a vehicle, and an emergency shipping instruction from the terminal, and this information is reflected in the generative AI on the server in real time. Specifically, the terminal executes a dedicated application providing a graphical user interface. The application parses plan data in a JSON format received from the server. The application stores the parsed data in a local SQLite database. The application dynamically updates a UI component on a screen using a data binding technology. The application displays a loading state of the vehicle as an interactive 3D model using a three-dimensional rendering engine. The application receives an operation in which a user rotates or scales the 3D model on a touch panel. The application receives an operation in which the user reallocates a specific task to another worker by drag and drop. The application captures the user's operation as an event object. The application serializes the event object and transmits it to the server via a secure WebSocket connection. The server analyzes the received event object and updates a corresponding state vector. The server re-executes a related optimization model based on the updated state vector. For example, when the user inputs an emergency shipping instruction, the server inserts the instruction at the head of a queue as a highest priority task. The server triggers the robot operation planning unit and the personnel allocation optimization unit, and generates a new schedule tensor. The server sends the generated schedule tensor back to the terminal. By this processing, the system seamlessly integrates a human override to a proposal of artificial intelligence. The system constructs a loop for feeding back tacit knowledge and intuition of a site to the system. The system minimizes an operation latency of the user and provides a stress-free operation environment. The system is applicable to a production management console of a factory and a control room of a distribution center. The application includes a cache mechanism so that the latest plan data can be browsed even in an offline state. When a network connection is restored, the application collectively synchronizes an operation log performed during offline to the server. The application dynamically limits information to be displayed and an operable function according to an authority level of the user. The application records all operation histories as an audit log, and ensures security and traceability.

As described above, in the embodiment of the present invention, each function of the warehousing and shipping optimization unit, the personnel allocation optimization unit, the transport robot operation planning unit, and the delivery vehicle loading planning unit is realized on the server using the generative AI, and the terminal is configured to play roles such as a user interface, data input/output, result visualization, and alert notification, whereby information of the entire logistics center is analyzed centrally in real time, a warehousing and shipping plan, personnel allocation, robot operation, vehicle loading, and risk response are optimized consistently, and elimination of logistics center fragmentation, business efficiency improvement, inventory optimization, operation optimization of personnel, robots, and vehicles, flexible response to external environment fluctuations, and totally optimized logistics center operation can be realized without depending on personal judgment or manual work. Specifically, the system includes a parallel computing cluster composed of a plurality of computing nodes as a server. The server is equipped with a large number of arithmetic processing units specialized for tensor operations. The server deploys a plurality of neural networks including a large language model and a time-series prediction model on a main memory. The system adopts a microservices architecture. The system executes the warehousing and shipping optimization unit, the personnel allocation optimization unit, the transport robot operation planning unit, and the delivery vehicle loading planning unit as independent software containers, respectively. The system dynamically allocates a computing resource according to a calculation load of each unit using a container orchestration tool. The system exchanges data between the respective units via a shared memory space or a high-speed message passing interface. The system receives a huge data stream transmitted from various sensors and terminals in the logistics center in real time. The system temporarily holds the received data in a distributed message queue. The system sequentially processes the data using a stream processing engine. The system stores the processed data in an in-memory database. The system maps these integrated data to a high-dimensional vector space using generative artificial intelligence. The system executes a multi-agent reinforcement learning algorithm for the respective optimization units to operate in cooperation with each other. The system updates a weight parameter so that each agent maximizes a reward as a whole while optimizing its own objective function. The system limits processing on the terminal side to drawing of a user interface and lightweight data input. The system offloads all heavy matrix operation processing to the server side. With this configuration, the system executes an advanced optimization calculation without depending on a hardware constraint of the terminal. The system reduces a communication overhead. The system significantly reduces a processing delay. The system prevents each subsystem in the logistics center from being siloed. The system generates a totally optimized plan with a response speed in milliseconds. By this technical effect, the system dramatically improves operation efficiency of a large-scale logistics network. The system is extremely useful in an application field requiring advanced real-time control, such as an e-commerce fulfillment center and a parts supply center in a manufacturing industry.

### System Configuration

The system according to the present embodiment includes a warehousing and shipping optimization unit, a personnel allocation optimization unit, a transport robot operation planning unit, a delivery vehicle loading planning unit, a data integration unit, a user interface unit, an alert notification unit, and an external cooperation unit. The warehousing and shipping optimization unit integrates various data such as scheduled receiving data, scheduled shipping data, inventory data, weather data, traffic condition data, economic indicator data, SNS trend data, and competitor trend data in a logistics center, learns a correlation of a plurality of factors such as past shipping performance, seasonal fluctuations, demand increase during campaigns, shipping decrease during bad weather, demand fluctuations at the time of competitor's new product introduction, and sudden demand increase at the time of sudden topic increase on SNS using generative AI, predicts shipping demand of each product in an arbitrary period such as the next one week or one month with high accuracy, and automatically generates a warehousing and shipping plan for optimizing a balance of receiving, shipping, and inventory and minimizing occurrence of a stockout or an excess inventory while maximizing an inventory turnover rate using an optimization algorithm such as a linear programming method, reinforcement learning, or an evolutionary algorithm in order to prevent the stockout or the excess inventory. For example, when a sudden demand increase of a specific product is predicted, receiving is advanced, or for a product with an excess inventory, a measure to delay receiving or promote shipping is proposed, inventory movement between a plurality of bases in the logistics center is also set as an optimization target, and when an inventory is excessive at a base A and an inventory is insufficient at a base B, an optimal inventory movement plan is automatically generated. Specific examples of a prompt sentence to be read by the generative AI include “Based on scheduled receiving data, scheduled shipping data, inventory data, weather data, traffic condition data, SNS trend data, and competitor trend data for the past two years, predict shipping demand of each product for the next one month, and optimize a warehousing and shipping plan for preventing a stockout or an excess inventory. Achieve total optimization including inventory movement between a plurality of bases.” and the like. Specifically, the warehousing and shipping optimization unit executes a transformer-based neural network equipped with a self-attention mechanism. The warehousing and shipping optimization unit converts various input data into a multidimensional tensor. The warehousing and shipping optimization unit encodes past shipping performance as a time-series vector. The warehousing and shipping optimization unit encodes weather data as a categorical variable vector. The warehousing and shipping optimization unit encodes trend data of a social network as a numerical vector. The warehousing and shipping optimization unit combines these vectors to generate an input tensor. For example, the warehousing and shipping optimization unit constructs an input tensor having an array of the number of sales of a specific product for the past 30 days, a numerical value of a precipitation probability, and the number of mentions of a specific keyword as elements. The neural network receives this input tensor. The neural network extracts a non-linear interaction of feature amounts through a multi-layered hidden layer. The neural network outputs a probability distribution tensor indicating a demand prediction value of each product for the next 30 days. For example, the neural network outputs an array of the predicted number of sales of a specific product for 30 days from tomorrow, and a predicted reliability score of each day. The warehousing and shipping optimization unit inputs this output probability distribution tensor to a subsequent mixed integer linear programming solver. The solver formulates an inventory holding cost, a transport cost, and a stockout penalty as an objective function. The solver searches for an optimal solution using a branch and bound method. The solver outputs a matrix indicating an optimal inventory movement amount between the respective bases. By this processing, the warehousing and shipping optimization unit elucidates a complex correlation in a high-dimensional space that cannot be intuitively grasped by a human. The warehousing and shipping optimization unit significantly reduces a calculation amount. The warehousing and shipping optimization unit dramatically reduces the inventory holding cost. The warehousing and shipping optimization unit minimizes an error of a demand prediction. The warehousing and shipping optimization unit exhibits an extremely high technical effect in supply chain management of a retail business having a plurality of logistics bases distributed over a wide area, and the like.

The personnel allocation optimization unit integrates various parameters such as worker shift data, skill information, a health condition, a congestion status of a work area, a priority and urgency of each work task, past work performance of a worker, productivity for each worker, a desired shift and leave application of a worker, an age and physical strength of a worker, and a qualification and license of a worker, and analyzes them by generative AI. For example, a personnel allocation plan for simultaneously realizing leveling of a workload, optimization of personnel costs, maximization of work efficiency, improvement of work quality, and improvement of worker satisfaction is automatically generated in real time, such as allocating many experienced workers in a time zone when picking work is concentrated, additionally introducing part-time workers at a timing when packing work increases, allocating light-load work to a worker in poor physical condition, distributing and allocating workers in a congested area, preferentially allocating a license holder to forklift work, maximally considering a desired shift and leave request of a worker, and allocating a double check to a worker who has made many mistakes in the past. Specific examples of a prompt sentence to be read by the generative AI include “Based on worker shift data, skill information, a health condition, a congestion status of a work area, a priority of a work task, past work performance, a desired shift, and qualification information, optimize a personnel allocation plan for this week. Simultaneously realize leveling of a workload, optimization of personnel costs, and improvement of work quality.” and the like. Specifically, the personnel allocation optimization unit calculates optimal matching between a worker and a task using a graph neural network. The personnel allocation optimization unit converts attribute information of a worker into a multidimensional worker skill vector. The personnel allocation optimization unit converts a requirement of each task into a task requirement matrix. The personnel allocation optimization unit acquires a congestion degree heat map extracted from a surveillance camera video of a work area as an image tensor. For example, the personnel allocation optimization unit constructs a forklift qualification flag of a specific worker, the required number of people for a specific task, and a congestion degree score of a specific area as input data. The graph neural network generates a bipartite graph composed of a worker node and a task node. The graph neural network executes a message passing algorithm to learn a relationship between nodes. The graph neural network outputs an adjacency matrix of the bipartite graph indicating an allocation probability of a worker and a task as a score matrix. For example, the graph neural network outputs a probability that a specific worker is allocated to a specific task as 0.95. The personnel allocation optimization unit inputs this output score matrix to a subsequent constraint satisfaction problem solver. The solver applies a constraint of an upper limit of working hours and a break time based on the Labor Standards Act as a hard constraint. The solver applies threshold processing to the score matrix. The solver determines a final shift table using a greedy algorithm or simulated annealing. By this processing, the personnel allocation optimization unit effectively prunes a search space in which a huge number of combinations exist. The personnel allocation optimization unit exponentially shortens a calculation time. The personnel allocation optimization unit quantifies a fatigue degree of a worker to prevent overwork. The personnel allocation optimization unit brings about a remarkable technical effect of maximizing a personnel operation rate in a labor-intensive huge warehouse operation and a distribution center of e-commerce with severe seasonal fluctuations.

The transport robot operation planning unit integrates various parameters such as a current position of each robot, an operation status, a remaining battery level, a transport capacity for each robot, a congestion degree of a work area, a priority and urgency of each work task, past operation performance of a robot, a failure history of a robot, a maintenance schedule of a robot, an operation time limit of a robot, and a loadable weight and a transport speed of a robot, and analyzes them by generative AI. For example, an operation plan for simultaneously realizing optimization of robot operation efficiency and battery consumption, improvement of safety of a work area, reduction of a failure risk of a robot, and improvement of maintenance efficiency is automatically generated, such as preferentially allocating a robot with a sufficient remaining battery level to long-distance transport, allocating a robot whose current location is close to a picking area, restricting entry of a robot into a congested area, allocating a short-distance task to a robot with a high failure risk, excluding a robot scheduled for maintenance from the operation plan, allocating a large robot to a task with a large loading weight, and allocating an emergency task to a robot with a fast transport speed. Specific examples of a prompt sentence to be read by the generative AI include “Based on a current position of each robot, an operation status, a remaining battery level, a transport capacity, a congestion degree of a work area, a priority of a work task, past operation performance, a failure history, and a maintenance schedule, optimize a transport robot operation plan for this week. Simultaneously realize optimization of operation efficiency and battery consumption, and reduction of a failure risk.” and the like. Specifically, the transport robot operation planning unit includes a neural network that executes a deep reinforcement learning algorithm. The transport robot operation planning unit collects sensor data of each robot. The transport robot operation planning unit generates a robot state vector including position coordinates and a remaining battery level. The transport robot operation planning unit divides a space in the logistics center into grids, and generates a space occupancy grid map indicating positions of obstacles and other robots as a two-dimensional array. For example, the transport robot operation planning unit constructs current coordinates of a specific robot, a numerical value of a remaining battery level of 80 percent, and an obstacle flag of a specific passage as input data. The neural network extracts a spatial feature from the space occupancy grid map using a convolutional layer. The neural network integrates it with the robot state vector using a fully connected layer. The neural network outputs an action value function score for a possible action of each robot. The neural network outputs a movement vector of a next step. For example, the neural network sets a value score in a forward direction to 0.8 and a value score in a right turn direction to 0.2, and outputs a movement vector. The transport robot operation planning unit inputs this output movement vector to a subsequent collision avoidance control module. The module fine-tunes a local path using a dynamic window approach. The module transmits a final control command to a motor drive unit of each robot to execute physical movement. By this processing, the transport robot operation planning unit completely avoids a situation in which a large number of robots fall into a deadlock at an intersection. The transport robot operation planning unit dramatically improves overall transport throughput. The transport robot operation planning unit optimizes a charge/discharge cycle of a battery to extend a life of hardware. The transport robot operation planning unit provides an extremely important technical improvement in a highly automated unmanned warehouse in which hundreds of autonomous mobile robots operate.

The delivery vehicle loading planning unit integrates various parameters such as a loadable amount of each vehicle, a current location, an operable time, a delivery destination route, traffic congestion information, a delivery delay risk due to weather, a shipping demand prediction, a driver's shift and break time, a remaining fuel level and a remaining battery level of the vehicle, a maintenance schedule of the vehicle, a delivery time designation for each delivery destination, an acceptable time zone of the delivery destination, and unloading facility information of the delivery destination, and analyzes them by generative AI. For example, a loading plan for simultaneously realizing maximization of loading efficiency of the vehicle and minimization of the delivery delay risk, optimization of labor management of the driver, improvement of delivery quality, and reduction of delivery cost is automatically generated, such as proposing mixed loading of a plurality of products to maximize the loading efficiency, adjusting a departure time and a delivery order to avoid a delay risk due to traffic congestion or bad weather, replacing the vehicle in consideration of the driver's binding time, allocating a nearest vehicle when an emergency shipment occurs, preferentially allocating an early time zone to a delivery destination with a strict delivery time designation, and additionally arranging personnel for a delivery destination without unloading facilities. Specific examples of a prompt sentence to be read by the generative AI include “Based on a loadable amount of each vehicle, a current location, an operable time, a delivery destination route, traffic congestion information, weather information, a shipping demand prediction, a driver's shift, a remaining fuel level, a maintenance schedule, a delivery time designation, and unloading facility information, optimize a delivery vehicle loading plan for this week. Simultaneously realize maximization of loading efficiency, minimization of a delivery delay risk, and optimization of labor management.” and the like. Specifically, the delivery vehicle loading planning unit executes an encoder-decoder model with an attention mechanism for simultaneously solving a three-dimensional packing problem and a traveling salesperson problem. The delivery vehicle loading planning unit generates a delivery destination coordinate matrix including a latitude and longitude of each delivery destination. The delivery vehicle loading planning unit generates baggage three-dimensional bounding box data having a width, a depth, and a height of each baggage as elements. For example, the delivery vehicle loading planning unit constructs a latitude and longitude numerical value of a specific delivery destination and a dimension numerical value array of specific baggage as input data. The encoder-decoder model receives these input data. An encoder of the model maps a geographical distance between delivery destinations and a physical constraint of baggage to a latent vector space. A decoder of the model autoregressively generates an optimal order and arrangement using a pointer network. The model outputs a three-dimensional vector indicating loading position coordinates of each baggage in a loading platform. The model outputs an integer array indicating a visit order sequence of each delivery destination. For example, the model outputs coordinates in a loading platform of specific baggage, and a visit order of a specific delivery destination as third. The delivery vehicle loading planning unit transmits this output visit order sequence to a subsequent navigation system. The delivery vehicle loading planning unit transmits the loading position coordinates to augmented reality glasses to superimpose and display them on a field of view of a worker, and guides loading work. By this processing, the delivery vehicle loading planning unit solves a combinatorial optimization problem in which a calculation amount explosively increases within a realistic time. The delivery vehicle loading planning unit increases a space utilization rate of a loading platform to the utmost limit. The delivery vehicle loading planning unit shortens a total travel distance of a vehicle to reduce carbon dioxide emissions. The delivery vehicle loading planning unit exhibits a remarkable technical effect in vehicle allocation work under a complex constraint such as last-mile delivery and long-distance trunk transport.

A data integration unit automatically collects various data such as sales performance data, scheduled receiving data, scheduled shipping data, inventory data, worker data, robot data, vehicle data, weather data, traffic data, economic indicator data, SNS trend data, and competitor trend data from various systems and databases inside and outside a logistics center, performs preprocessing such as format conversion, data cleansing, missing value completion, time-series matching, and data normalization, and centrally stores them on a server in a form usable by each unit. For example, sales data acquired from a POS system, inventory data acquired from a logistics management system, and weather data acquired from an external API are matched in time series, and converted into a format easy for generative AI to learn. In addition, the data integration unit also performs abnormal value detection of data, exclusion of duplicate data, automatic mapping of data, and the like to maintain data quality. Furthermore, the data integration unit manages an update frequency and an acquisition timing of data to ensure real-time property. Specifically, the data integration unit includes a data processing engine that automatically controls an extraction, transformation, and loading pipeline. The data integration unit receives raw data in heterogeneous formats as an input. For example, the data integration unit acquires a comma-separated value file from a point-of-sale information management system and a response in a JSON format from a weather information providing server as input data. The data integration unit executes a neural network using an autoencoder to perform missing value completion. The data integration unit executes a dynamic time warping algorithm to match a time axis between time-series data having different sampling rates. The data integration unit removes noise data using an outlier detection algorithm. The data integration unit scales all numerical data to a range from zero to one. The data integration unit converts categorical data into a one-hot vector. The data integration unit outputs a normalized feature amount tensor through these preprocessings. For example, the data integration unit outputs a sales vector expressed as a floating-point array. The data integration unit arranges this output feature amount tensor in a subsequent shared memory space. The data integration unit directly supplies this tensor to an input layer of a neural network of each optimization unit. By this processing, the data integration unit significantly improves a learning convergence speed of a subsequent artificial intelligence model. The data integration unit eliminates instability during learning such as vanishing gradient and exploding gradient. The data integration unit eliminates a bottleneck in data input/output, and maximizes processing throughput of the entire system. The data integration unit brings about an extremely important technical effect of guaranteeing completeness and consistency of data in a big data analysis platform handling a wide variety of data sources.

The user interface unit enables an on-site person in charge or an administrator to view results of a warehousing and shipping plan, a personnel allocation plan, a robot operation plan, and a vehicle loading plan executed on a server in a dashboard or report format, and visualizes a scheduled warehousing and shipping graph of each product, a worker allocation table, a robot operation schedule, a vehicle loading plan table, a risk alert list, a recommended action list, and the like. The person in charge can also input information such as a new scheduled receiving, a shipping instruction, a worker shift request, a robot maintenance schedule, an additional vehicle arrangement, and an emergency shipping instruction from a terminal, and these pieces of information are reflected in the generative AI on the server in real time. Specifically, the user interface unit includes a drawing engine configured to render a three-dimensional visualization object using a web graphics library. The user interface unit adopts an architecture in which a front end and a back end are separated. The user interface unit redraws only a difference of a screen at high speed using a virtual document object model. The user interface unit acquires user operation log data as an input. For example, the user interface unit collects coordinate data of a click event of a specific button or a character string vector input to a text box as input data. The user interface unit executes a natural language processing model to analyze an intention of the input text. The user interface unit outputs label data classifying the user's intention and an importance score thereof. For example, the user interface unit outputs the intention label as a shipping instruction and the importance score as 0.99. The user interface unit calls a specific endpoint of a subsequent back end via an asynchronous communication protocol based on the output label data. The user interface unit immediately triggers a recalculation process of the plan on the server side. The user interface unit converts a user operation history into a reward signal of reinforcement learning and uses it for online learning of an artificial intelligence model. By this processing, the user interface unit realizes smooth operability while minimizing a drawing load on the terminal side. The user interface unit feeds back implicit knowledge of the user to the system and continuously improves adaptability of the model. The user interface unit exhibits a technical effect of reducing a human cognitive load by allowing complex logistics data to be intuitively grasped.

The alert notification unit detects various risks such as a stockout risk, an excess inventory risk, a worker shortage risk, a robot failure risk, and a delivery delay risk in real time based on risk information and a recommended action output from the warehousing and shipping plan, the personnel allocation plan, the robot operation plan, and the vehicle loading plan, and immediately notifies them via a terminal of the person in charge, an e-mail, a chat tool, a mobile application, or the like. For example, when a prediction that an inventory of a specific product will become zero after three days is output, an alert prompting an emergency order is automatically transmitted to a person in charge of a purchasing department. In addition, when a logistics delay occurs, a notification prompting an arrangement of an alternative transportation means is sent to a person in charge of a logistics department. Furthermore, the alert notification unit automatically switches a notification method and a notification destination according to a severity and an urgency of the risk. Specifically, the alert notification unit executes an anomaly detection model based on an isolation forest algorithm. The alert notification unit acquires a prediction tensor output from each planning unit and a time-series array of a system log as input data. For example, the alert notification unit constructs an array of future inventory prediction values of each product and time-series data of a processor usage rate of the server as an input tensor. The anomaly detection model calculates a pattern deviating from a normal data distribution. The anomaly detection model outputs an anomaly score which is a continuous value in a range from zero to one. The anomaly detection model outputs a classification label of an anomaly factor. For example, the anomaly detection model outputs the anomaly score as 0.85 and the classification label as an inventory depletion risk. The alert notification unit inputs the output anomaly score to a subsequent determination module. The determination module determines whether or not the anomaly score exceeds a dynamically set threshold value. When the threshold value is exceeded, the determination module generates a specific alert message via a publish-subscribe messaging system. The messaging system push-delivers the message to a registered client terminal. By this processing, the alert notification unit captures an unknown anomaly pattern overlooked by conventional rule-based detection based on a fixed threshold value with high accuracy. The alert notification unit significantly reduces a false positive rate and prevents user fatigue due to unnecessary notifications. The alert notification unit minimizes system latency and distributes a load by asynchronous delivery of messages. The alert notification unit provides an extremely important technical effect of preventing a fatal failure in mission-critical supply chain operations.

The external linkage unit has a function of performing data linkage in real time with various external systems and databases such as a POS system, an inventory management system, a logistics management system, an accounting system, an external weather information service, an economic indicator database, and an SNS analysis service. For example, it automatically acquires sales performance data from the POS system, acquires an inventory movement history from the logistics management system, acquires weather data from the external weather information service, and acquires topic volume data regarding products from the SNS analysis service. The external linkage unit supports various linkage methods such as API linkage, file linkage, batch processing, and streaming processing, and also considers data security and privacy protection. Specifically, the external linkage unit includes a communication interface based on a remote procedure call protocol and a representational state transfer architecture. The external linkage unit establishes a secure communication channel with an external system. The external linkage unit receives an authentication token and encrypted payload data as an input from an external application programming interface. For example, the external linkage unit acquires an access token of an open authentication protocol or a JSON character string encrypted by an advanced encryption standard as input data. The external linkage unit manages an encryption key using a hardware security module and decrypts the payload data. The external linkage unit parses the decrypted data and outputs structured data. For example, the external linkage unit outputs dictionary-format data in which a product identifier and a numerical value of a topic volume are paired. The external linkage unit transfers the output structured data to a subsequent distributed message queue. The external linkage unit streaming-supplies the data to an extraction, transformation, and loading pipeline of the data integration unit. When a communication error or a timeout occurs, the external linkage unit automatically executes a retry process using an exponential backoff algorithm. By this processing, the external linkage unit completely prevents data loss caused by instability of an external network. The external linkage unit improves scalability of the entire system. The external linkage unit brings about a technical effect of realizing seamless interoperability between heterogeneous environments while strongly protecting highly confidential business data.

As described above, the system according to the present embodiment includes the warehousing and shipping optimization unit, the personnel allocation optimization unit, the transport robot operation planning unit, the delivery vehicle loading planning unit, the data integration unit, the user interface unit, the alert notification unit, and the external linkage unit, and each unit cooperates to analyze information of the entire logistics center in real time and centrally, optimizes the warehousing and shipping plan, the personnel allocation, the robot operation, the vehicle loading, and the risk response in an integrated manner, and can realize elimination of logistics center fragmentation, business efficiency improvement, inventory optimization, operation optimization of personnel, robots, and vehicles, flexible response to external environment fluctuations, and totally optimized logistics center operation without depending on personal judgment or manual work. Specifically, the system implements each functional unit as an independent microservice and deploys it on a server cluster using container virtualization technology. The system introduces a service mesh architecture to highly control communication traffic between the microservices. The system caches intermediate tensor data generated by each unit in an in-memory data grid. By this cache mechanism, the system eliminates a disk read/write delay when different optimization units access the same data set. The system executes a metaheuristics algorithm that supervises total optimization. The system models an influence of a change in the warehousing and shipping plan on the personnel allocation and the robot operation using a partial differential equation. The system integrates output vectors from the respective optimization units and searches for a global optimal solution that minimizes an energy function of the entire system. The system provides a fault tolerance function in which a container orchestrator automatically restarts a service on an alternative node when a hardware failure occurs. With this configuration, the system eliminates a single point of failure and guarantees high availability of the system. The system mathematically guarantees true total optimization, not a collection of local optimizations. The system maximizes utilization efficiency of calculation resources and reduces power consumption. The system exhibits an outstanding technical effect of providing a robust information processing infrastructure that autonomously and instantaneously adapts to rapid fluctuations in an external environment in a modern supply chain network that is complexly intertwined.

### Implementation Steps

### Step 1: Data Collection and Integration

Various data such as scheduled receiving data, scheduled shipping data, inventory data, worker data, transport robot data, delivery vehicle data, weather data, traffic condition data, economic indicator data, SNS trend data, and competitor trend data are automatically collected from various systems and databases inside and outside the logistics center, preprocessing such as format conversion, data cleansing, missing value completion, time-series alignment, and data normalization is performed, and the data is centrally stored on the server in a form usable by each unit. For example, sales data acquired from the POS system, inventory data acquired from the logistics management system, and weather data acquired from an external API are aligned in time series and converted into a format that is easy for the generative AI to learn. Specifically, in this step, the system executes a lambda architecture integrating batch processing and stream processing. The system continuously takes in raw data from various data sources as an input. For example, the system acquires a daily sales file from a point-of-sale information management system or stream data in a JSON format updated every second from a weather information providing server as input data. The system activates a feature engineering module. The module completes missing values using a k-nearest neighbor algorithm. The module aligns time-series data having different sampling periods in milliseconds using dynamic time warping. The module standardizes all numerical data so as to follow a standard normal distribution. The module outputs a normalized feature tensor for which these preprocessings have been completed. For example, the module outputs a multidimensional array scaled such that a mean is zero and a variance is one. The system writes the output feature tensor to a subsequent distributed in-memory database. By this processing, the system completely eliminates a bottleneck of disk input/output. The system maintains data freshness extremely high. The system brings about a technical effect of enabling a subsequent artificial intelligence model to perform learning and inference with high-quality data without noise, and dramatically improving a convergence speed and prediction accuracy of the model.

### Step 2: Demand and Warehousing/Shipping Prediction Model Generation

The integrated scheduled receiving data, scheduled shipping data, inventory data, weather data, traffic condition data, economic indicator data, SNS trend data, competitor trend data, and the like are input to the generative AI, a correlation of a plurality of factors such as past shipping performance, seasonal fluctuations, demand increase during campaigns, shipping decrease during bad weather, demand fluctuations at the time of competitor new product introduction, and sudden demand increase at the time of sudden topic increase on SNS is learned, and a model for predicting shipping demand of each product in an arbitrary period such as the next one week or one month with high accuracy is generated. As a specific example of a prompt sentence to be read by the generative AI, “Based on scheduled receiving data, scheduled shipping data, inventory data, weather data, traffic condition data, SNS trend data, and competitor trend data for the past two years, predict shipping demand of each product for the next one month, and optimize a warehousing and shipping plan for preventing a stockout or an excess inventory. Achieve total optimization including inventory movement between a plurality of bases.” is given. Specifically, in this step, the system executes a large language model fine-tuned using a low-rank adaptation method. The system receives the normalized feature tensor generated in the previous step and a natural language prompt as an input. The system divides the prompt text into a token sequence using a tokenizer. The system converts the token sequence into a high-dimensional embedding vector using an embedding layer. The system combines the feature tensor and the embedding vector and inputs them to the model. The model simultaneously analyzes a long-term dependency of time-series data and a context of text using a multi-head self-attention mechanism. The model outputs a probability distribution tensor indicating a future demand prediction value of each product. For example, the model outputs a predicted sales quantity array of a specific product for the next thirty days and confidence interval data indicating a variance of each prediction value. The system holds the output probability distribution tensor in a memory as an input parameter of a subsequent optimization solver. By this processing, the system processes numerical data and unstructured text data in the same latent space. The system extracts a complex causal relationship that could not be captured by conventional statistical methods. The system dramatically improves accuracy of zero-shot inference. The system exhibits a remarkable technical effect of minimizing an error in demand prediction and eliminating uncertainty of the entire supply chain.

### Step 3: Warehousing and Shipping Optimization Plan Formulation

Based on an output result of the demand prediction model by the generative AI, inventory data, scheduled receiving data, scheduled shipping data, and external factors such as weather and traffic conditions, a warehousing and shipping plan for minimizing occurrence of a stockout or an excess inventory while maximizing an inventory turnover rate is automatically generated using an optimization method such as a linear programming method, reinforcement learning, or an evolutionary algorithm. For example, when a sudden demand increase of a specific product is predicted, a measure of advancing receiving, or delaying receiving or promoting shipping for a product with an excess inventory is proposed, and inventory movement between a plurality of bases in the logistics center is also set as an optimization target. Specifically, in this step, the system executes a deep reinforcement learning algorithm based on an actor-critic method on an environment formulated as a Markov decision process. The system acquires the probability distribution tensor output in the previous step, a current inventory amount vector, and a transportation cost matrix between bases as an input state. An actor network of the algorithm calculates a probability distribution of an optimal action from a current state. A critic network of the algorithm evaluates a value function of the state and calculates a reward prediction error. The system outputs an optimal action vector indicating an optimal inventory movement amount between the respective bases and an order timing. For example, the system outputs an integer value indicating a movement amount of a specific product from a base A to a base B and a flag for advancing an order by three days. The system transmits the output optimal action vector to a subsequent core business system, and automatically executes an actual ordering process and movement instruction. By this processing, the system avoids a local optimal solution that is easy to fall into in a static rule base. The system executes dynamic programming considering future uncertainty at high speed. The system mathematically optimizes a trade-off between an inventory holding cost and a transportation cost. The system brings about a technical effect of deriving a global optimal solution while efficiently using calculation resources in a large-scale logistics network.

### Step 4: Personnel Allocation Optimization Plan Formulation

Various parameters such as worker shift data, skill information, a health condition, a congestion status of a work area, a priority and urgency of each work task, past work performance of workers, a requested shift and leave application, and qualifications and licenses are input to the generative AI, and a personnel allocation plan for simultaneously realizing leveling of a workload, optimization of personnel costs, maximization of work efficiency, improvement of work quality, and improvement of worker satisfaction is automatically generated in real time. As a specific example of a prompt sentence to be read by the generative AI, “Based on worker shift data, skill information, a health condition, a congestion status of a work area, a priority of a work task, past work performance, a requested shift, and qualification information, optimize a personnel allocation plan for this week. Simultaneously realize leveling of a workload, optimization of personnel costs, and improvement of work quality.” is given. Specifically, in this step, the system executes a hybrid optimization engine combining a genetic algorithm and a neural network. The system acquires a multidimensional vector indicating worker attributes and a matrix indicating task requirements as input data. The system encodes a shift pattern into a bit string as a chromosome. The system calculates a fitness function of each chromosome at high speed using the neural network. The system advances generation alternation by repeatedly applying crossover, mutation, and selection operators. The system decodes a chromosome having the highest fitness and outputs a two-dimensional array indicating an optimal allocation of workers and tasks. For example, the system outputs a flag array indicating that a specific worker is allocated to a specific picking area in a specific time zone. The system transmits the output two-dimensional array to a subsequent user interface unit, and renders it on a screen as a shift table. By this processing, the system discovers a sub-optimal solution from a vast search space in an extremely short time for a personnel allocation problem which is an NP-hard combinatorial optimization problem. The system significantly shortens a processing time by parallelizing calculation. The system exhibits a technical effect of automatically generating a shift that simultaneously satisfies compliance with labor laws and regulations and maximization of productivity, and eliminating a cognitive load on an administrator for plan formulation.

### Step 5: Transport Robot Operation Plan Formulation

Various parameters such as a current position of each robot, an operation status, a remaining battery level, a transport capacity, a congestion degree of a work area, a priority and urgency of a work task, past operation performance, a failure history, and a maintenance schedule are input to the generative AI, and a transport robot operation plan for simultaneously realizing optimization of robot operation efficiency and battery consumption, improvement of safety of the work area, reduction of a failure risk, and improvement of maintenance efficiency is automatically generated. As a specific example of a prompt sentence to be read by the generative AI, “Based on a current position of each robot, an operation status, a remaining battery level, a transport capacity, a congestion degree of a work area, a priority of a work task, past operation performance, a failure history, and a maintenance schedule, optimize a transport robot operation plan for this week. Simultaneously realize optimization of operation efficiency and battery consumption, and reduction of a failure risk.” is given. Specifically, in this step, the system activates a control module that executes a multi-agent path search algorithm. The system acquires a state vector indicating current coordinates and a remaining battery level of each robot, and graph structure data indicating a layout in a warehouse as an input. The system treats each robot as a node on a graph and constructs a spatio-temporal network to which a time axis is added. The system calculates a path for avoiding a collision or a deadlock between robots using a conflict-based search algorithm. The system outputs a spatio-temporal reservation table indicating a future movement path and task allocation of each robot. For example, the system outputs a series of command sequences in which a specific robot passes through a node X at a time T and acquires a load at a node Y at a time T plus one. The system transmits the output spatio-temporal reservation table to a subsequent robot group control server, and converts it into motor control of each machine. By this processing, the system realizes parallelization of path calculation and enables real-time control for a robot group of a scale of several hundreds. The system minimizes a useless waiting time and a detour path, and dramatically reduces battery consumption. The system brings about an outstanding technical effect of completely preventing a physical collision accident and maximizing an operation rate of an automated warehouse.

Step 6: Delivery Vehicle Loading Plan Formulation Various parameters such as a loadable amount of each vehicle, a current location, an operable time, a delivery destination route, traffic congestion information, a delivery delay risk due to weather, a shipping demand prediction, a driver's shift and break time, a remaining fuel level and a remaining battery level, a maintenance schedule, a delivery time designation, and unloading facility information are input to the generative AI, and a delivery vehicle loading plan that simultaneously realizes maximization of loading efficiency, minimization of the delivery delay risk, optimization of labor management, improvement of delivery quality, and reduction of a delivery cost is automatically generated. As a specific example of a prompt sentence to be read by the generative AI, “Optimize a delivery vehicle loading plan for this week based on a loadable amount of each vehicle, a current location, an operable time, a delivery destination route, traffic congestion information, weather information, a shipping demand prediction, a driver's shift, a remaining fuel level, a maintenance schedule, a delivery time designation, and unloading facility information. Simultaneously realize maximization of loading efficiency, minimization of a delivery delay risk, and optimization of labor management.” is given. Specifically, in this step, the system executes a deep reinforcement learning model for a three-dimensional bin packing problem. The system acquires a three-dimensional voxel representation tensor indicating an empty space of a loading platform of a vehicle and a feature amount matrix indicating dimensions and a weight of a load to be loaded as input data. The model extracts geometric features of a voxel space using a convolutional neural network. The model sets maximization of a filling rate and stability of a center of gravity as a reward function, and learns using a policy gradient method. The model outputs an action vector indicating optimal arrangement coordinates, a rotation angle, and a loading order of each load. For example, the model outputs data setting XYZ coordinates in the loading platform of a specific load, a 90-degree rotation instruction, and a loading order to be first. The system transmits the output action vector to a subsequent warehouse management system, and uses it as instruction data for picking and loading work. By this processing, the system mathematically solves a complex space filling problem that has relied on tacit knowledge of skilled workers. The system instantaneously generates a loading plan that completely satisfies physical constraints while suppressing a combinatorial explosion. The system exhibits a technical effect of significantly reducing a logistics cost and an environmental load by raising a loading rate of a vehicle to a limit and reducing the number of necessary vehicles.

Step 7: Risk Detection and Alert Notification Based on risk information and a recommended action output from a warehousing and shipping plan, a personnel allocation plan, a robot operation plan, and a vehicle loading plan, various risks such as a stockout risk, an excess inventory risk, a worker shortage risk, a robot failure risk, and a delivery delay risk are detected in real time, and are immediately notified through a terminal of a person in charge, an e-mail, a chat tool, a mobile application, or the like. For example, when a prediction that an inventory of a specific product will become zero after three days is output, an alert prompting a person in charge of a purchasing department to place an emergency order is automatically transmitted, and when a logistics delay occurs, a notification prompting a person in charge of a logistics department to arrange an alternative transportation means is performed. Specifically, in this step, the system executes a time-series anomaly detection model combining a long short-term memory network and an autoencoder. The system acquires a prediction tensor output from each planning unit and a time-series array such as vibration data of equipment collected from a sensor as an input. The model compresses input data into a latent space, and then reconstructs original data. The model calculates a reconstruction error between the input data and reconstructed data. The model outputs this reconstruction error as an anomaly score, and further outputs a classification label indicating a cause of an anomaly. For example, the model outputs the anomaly score as 0.92 and the classification label as a failure sign of a robot drive system. The system inputs the output anomaly score and classification label to a subsequent rule engine. The rule engine collates with a dynamically updated threshold matrix, and generates a specific alert payload when an alerting condition is satisfied. The system asynchronously transmits a push notification to the terminal of the corresponding person in charge via a message broker. By this processing, the system early discovers a minute fluctuation or an anomaly of a complex pattern that cannot be detected by a simple threshold determination. The system reduces a false detection rate and realizes optimal allocation of calculation resources. The system brings about an extremely important technical effect of preventing occurrence of downtime and guaranteeing continuous operation of a supply chain.

Step 8: Decision-Making Support by User Interface A user interface unit visualizes results of a warehousing and shipping plan, a personnel allocation plan, a robot operation plan, and a vehicle loading plan, a risk alert, a recommended action, and the like in a dashboard or report format, so that a field person in charge or an administrator can intuitively grasp a situation, and can input a new scheduled receiving or shipping instruction, a worker's shift request, a robot maintenance schedule, an additional arrangement of a vehicle, an emergency shipping instruction, and the like as necessary. These pieces of input information are reflected in the generative AI on a server in real time, and are immediately reflected in each subsequent step. Specifically, in this step, the system executes a web client based on a single-page application architecture. The system receives plan data in a JSON format and an alert tensor transmitted from the server as an input. The system updates a rendering tree of a browser with a minimum calculation amount using a virtual document object model. The system captures an input operation from a user with an event listener, and vectorizes an operation content. For example, the system generates an operation vector having a time stamp when the user clicks an emergency shipping button, a target product identifier, and a numerical value of an input quantity as elements. The system immediately transmits this operation vector to a back-end server via WebSocket communication. The system feeds back this vector to an input layer of an artificial intelligence model operating on a server side, and triggers a weight update of online learning and a recalculation process of a plan. By this processing, the system maximizes rendering performance of a front end, and realizes responsiveness that does not make the user feel a delay. The system constructs a cooperative loop between a human and a machine, and continuously improves prediction accuracy of the model. The system exhibits a technical effect of visually simplifying a complex data structure and supporting quick and accurate decision-making by the administrator.

### Specific Use Case

For example, a case is assumed in which overall optimization for responding to a period of a rapid increase in beverage demand in summer is executed in a logistics center having a plurality of bases nationwide. First, a scheduled delivery date, a product, and a quantity from each supplier as scheduled receiving data, a scheduled shipping date, a product, and a quantity to each customer as scheduled shipping data, a current inventory quantity and a location for each base and each product as inventory data, temperature, rainfall, and typhoon information as weather data, congestion, accident, and road closure information of major roads as traffic condition data, a consumption trend and a price index as economic indicator data, a topic volume of a beverage product as SNS trend data, new release information and price revision information of a competitor product as competitor trend data, a shift, a skill, a health condition, a desired shift, and qualification information as worker data, a current position, an operation status, a remaining battery level, a transport capacity, a failure history, and a maintenance schedule as transport robot data, and a loadable amount, a current location, an operable time, a remaining fuel level, a delivery time designation, and unloading facility information as delivery vehicle data are collected. Specifically, the system executes sensor fusion utilizing a large number of edge computing devices distributed and arranged in a wide area network. The system samples raw data at a high frequency from an environmental sensor, a surveillance camera, and a programmable logic controller of equipment installed at each base. The system executes primary data filtering and a compression algorithm on an edge device. For example, the system extracts only skeletal coordinates of a person from a video stream of the surveillance camera, and generates tensor data in which a data size is compressed to a fraction of several thousands. The system smoothes latitude and longitude data obtained from a global positioning system receiver of each vehicle using a Kalman filter, and generates a trajectory vector from which noise is removed. The system transmits these preprocessed data to a central cloud server through a virtual private network encrypted by a transport layer security protocol. By this processing, the system dramatically reduces consumption of a network bandwidth to a cloud side. The system prevents obsolescence of data due to a communication delay. The system brings about a technical effect of safely and efficiently collecting big data generated from a huge number of Internet of Things devices without loss or falsification, and constructing a robust foundation for subsequent advanced artificial intelligence analysis.

A data integration unit collects and preprocesses these diverse data in real time, performs time-series matching, missing value complementation, outlier detection, and data normalization, and converts them into a format learnable by the generative AI. A warehousing and shipping optimization unit gives a prompt sentence “Predict shipping demand for each product for the next one month based on scheduled receiving data, scheduled shipping data, inventory data, weather data, traffic condition data, SNS trend data, and competitor trend data for the past two years, and optimize a warehousing and shipping plan for preventing a stockout or an excess inventory. Achieve overall optimization including inventory movement among a plurality of bases.” to the generative AI, generates a demand prediction model, and automatically generates a warehousing and shipping plan that simultaneously realizes maximization of an inventory turnover rate and minimization of a stockout and a surplus inventory. Specifically, the data integration unit executes massively parallel query processing on a distributed database system. The data integration unit expands the collected data into an in-memory data grid, and stores it in a column-oriented format. The data integration unit automatically converts a natural language prompt into a structured query language query or a tensor operation graph using a large language model. The warehousing and shipping optimization unit executes a tensor product operation in parallel on a graphics processing unit cluster based on the converted operation graph. The warehousing and shipping optimization unit drives an autoregressive time-series prediction model using a past data set as an input. The warehousing and shipping optimization unit outputs a multidimensional tensor indicating a future demand probability distribution regarding each product at each base. For example, the warehousing and shipping optimization unit outputs a predicted demand amount array for 30 days from tomorrow for a product D at a base C, and a certainty score of the prediction. The warehousing and shipping optimization unit inputs this output tensor to a subsequent distributed optimization solver. The solver solves a huge linear programming problem having millions of variables and constraint conditions using a dual simplex method. By this processing, the system shortens batch processing that conventionally required several hours to near real-time processing in units of several seconds to several minutes. The system shortens a query response time for a large-scale data set to a limit. The system exhibits an outstanding technical effect of deriving a mathematically proven optimal solution from combinations of complex inventory movements among a plurality of bases, and maximizing a profit of the entire supply chain.

A personnel allocation optimization unit gives a prompt sentence “Optimize a personnel allocation plan for this week based on worker shift data, skill information, a health condition, a congestion status of a work area, a priority of a work task, past work performance, a desired shift, and qualification information. Simultaneously realize leveling of a workload, optimization of personnel costs, and improvement of work quality.” to the generative AI, and automatically generates a personnel allocation plan that maximally considers a field situation and worker characteristics, such as allocating many experienced workers in a time zone when picking work is concentrated, additionally introducing part-time workers at a timing when packing work increases, assigning light-load work to a worker in poor physical condition, and preferentially assigning a license holder to forklift work. Specifically, the personnel allocation optimization unit converts a plurality of input data into a multidimensional numerical vector. The personnel allocation optimization unit digitizes worker shift data and skill information by one-hot encoding. The personnel allocation optimization unit acquires a congestion status of a work area as a time-series floating-point array. The personnel allocation optimization unit combines these numerical data to generate an input tensor. The number of dimensions of the input tensor is, for example, 256 dimensions. Elements of the input tensor include an identifier of each worker, a numerical value of a skill level, and a task priority score for each time zone. As a specific example, the input tensor includes binary data indicating presence or absence of a forklift license, an integer value indicating the number of picking processing cases in the past one week, and a health condition score acquired from a current heart rate sensor. The personnel allocation optimization unit inputs this input tensor to a hybrid artificial intelligence model combining a large language model and a graph neural network. The artificial intelligence model adopts a transformer architecture. The artificial intelligence model calculates a hidden correlation between a worker's skill and a required characteristic of a task using a self-attention mechanism. The artificial intelligence model executes matrix multiplication in a high-dimensional space. The artificial intelligence model generates a task allocation probability distribution for each worker as an output. A format of output data is a multidimensional probability tensor indicating task allocation by time zone for each worker. Each output value means a success probability that a specific worker completes a specific task in a specific time zone. As a specific example, the output data includes a numerical value indicating that a probability that a worker A is in charge of picking work at 9:00 a.m. is 0.95. As another specific example, the output data includes a numerical value indicating that a probability that a worker B is in charge of packing work at 2:00 p.m. is 0.88. The personnel allocation optimization unit executes a threshold determination on this output tensor. The personnel allocation optimization unit confirms an allocation having a probability exceeding 0.8. The personnel allocation optimization unit stores the confirmed allocation information as structured data in a relational database. The personnel allocation optimization unit transmits this structured data to a mobile terminal of each worker. By this processing, conventional shift creation work depending on human intuition is eliminated. This processing efficiently utilizes computer resources and significantly shortens a calculation time for personnel allocation. This processing brings about a technical effect of improving work efficiency by leveling a workload. The artificial intelligence model learns a weight parameter in advance using an error backpropagation method so as to minimize an error between past allocation performance and an actual work completion time. A loss function of the artificial intelligence model is defined by a linear combination of a cross-entropy error and a personnel cost penalty term. By using this learned model, the system dynamically generates a highly accurate personnel allocation plan even for an unknown demand fluctuation. This technology is applicable to a personnel management system in a large-scale logistics center or a manufacturing plant.

A transport robot operation planning unit gives a prompt sentence “Optimize a transport robot operation plan for this week based on a current position of each robot, an operation status, a remaining battery level, a transport capacity, a congestion degree of a work area, a priority of a work task, past operation performance, a failure history, and a maintenance schedule. Simultaneously realize optimization of operation efficiency and battery consumption, and reduction of a failure risk.” to the generative AI, and automatically generates a plan that achieves both operation efficiency and safety of a robot, such as allocating a robot with a sufficient remaining battery level to long-distance transport, restricting entry into a congested area, and excluding a robot scheduled for maintenance from an operation plan. Specifically, the transport robot operation planning unit collects sensor data transmitted from each robot in real time. The transport robot operation planning unit normalizes the collected data and constructs an input tensor. The number of dimensions of the input tensor is, for example, 512 dimensions. Elements of the input tensor include two-dimensional coordinate data of each robot, a floating-point value of a battery voltage, and an integer value of a transportable weight. As a specific example, the input tensor includes an XY coordinate value indicating a current position of a robot C, a percentage value indicating a remaining battery level, and a time-series array of a motor temperature for the latest one month. The transport robot operation planning unit inputs this input tensor to a deep reinforcement learning model. The deep reinforcement learning model includes a convolutional neural network and a long short-term memory network. The deep reinforcement learning model simultaneously extracts a spatial feature of a work area and a temporal change in an operation status of a robot. The deep reinforcement learning model calculates a state transition probability based on a Markov decision process. The deep reinforcement learning model generates a score matrix of an action value function for each robot as an output. A format of output data is an array of expected reward values for combinations of movement routes and tasks selectable by each robot. Each output value means a comprehensive evaluation score of energy efficiency and task completion when a specific route is selected. As a specific example, the output data includes a numerical value indicating that a score of an action in which the robot C transports a load via a route D is 95 points. As another specific example, the output data includes a numerical value indicating that a score of an action in which a robot E returns to a charging station is 89 points. The transport robot operation planning unit selects a maximum value of this score matrix. The transport robot operation planning unit generates a specific control command based on the selected action. The transport robot operation planning unit transmits the generated control command to a drive control module of each robot via a wireless communication network. By this processing, dynamic obstacle avoidance and optimization of battery consumption, which are difficult to cope with by a rule-based route search algorithm, are realized. This processing brings about a technical effect of preventing a collision of a robot group and improving overall transport throughput. The deep reinforcement learning model updates a weight of a network using a policy gradient method so as to maximize a reward function through trial and error in a simulation environment. The reward function is designed to give a positive reward upon task completion and give a negative penalty upon battery depletion or collision. By using this learned model, the system executes autonomous and efficient robot group control even in a complex environment. This technology is applicable to an automated warehouse or a manufacturing line introducing an automated guided vehicle.

A delivery vehicle loading planning unit gives a prompt sentence “Optimize a delivery vehicle loading plan for this week based on a loadable amount of each vehicle, a current location, an operable time, a delivery destination route, traffic congestion information, weather information, a shipping demand prediction, a driver's shift, a remaining fuel level, a maintenance schedule, a delivery time designation, and unloading facility information. Simultaneously realize maximization of loading efficiency, minimization of a delivery delay risk, and optimization of labor management.” to the generative AI, and automatically generates a loading plan considering field constraints and an external environment, such as avoiding a delay risk due to traffic congestion or weather deterioration while maximizing loading efficiency, and preferentially allocating an early time zone to a delivery destination with a strict delivery time designation. Specifically, the delivery vehicle loading planning unit integrates physical constraints of a vehicle and external environment data, and generates a multidimensional input tensor. The delivery vehicle loading planning unit acquires traffic congestion information and weather information from an external application programming interface. The delivery vehicle loading planning unit converts the acquired information into a time-series numerical vector. The number of dimensions of the input tensor is, for example, 1024 dimensions. Elements of the input tensor include a maximum loading volume of each vehicle, latitude and longitude information of a delivery destination, and a time stamp of a designated delivery time. As a specific example, the input tensor includes three-dimensional dimension data of a loading platform of a vehicle F, a numerical range indicating an allowable delivery time frame of a delivery destination G, and a floating-point value of a precipitation probability on a route. The delivery vehicle loading planning unit inputs this input tensor to an artificial intelligence model combining a graph convolutional network and a variational autoencoder. The artificial intelligence model expresses a delivery network as a graph structure composed of nodes and edges. The artificial intelligence model executes a graph convolution operation, and learns a spatial dependency relationship between nodes. The artificial intelligence model generates an allocation matrix of a load to each vehicle and a permutation vector of a delivery order as an output. A format of output data is a binary matrix indicating mapping of a vehicle identifier and a load identifier, and an integer array indicating a visit order. Each output value means a determination result that it is optimal to load a specific load on a specific vehicle and deliver it in a specific order. As a specific example, the output data includes a flag value indicating that a load H is allocated to the vehicle F. As another specific example, the output data includes an order index value indicating that the vehicle F visits the delivery destination G second. The delivery vehicle loading planning unit executes a three-dimensional loading simulation based on this output data. The delivery vehicle loading planning unit confirms that there is no physical interference of loads. The delivery vehicle loading planning unit transmits the confirmed loading plan to a warehouse management system. By this processing, an inefficient vehicle allocation plan depending on a human rule of thumb is eliminated. This processing brings about a technical effect of maximizing a loading rate of a vehicle and reducing a total travel distance and fuel consumption. The artificial intelligence model is learned by a gradient descent method so as to minimize a square error of a delivery delay time using past delivery performance data. By using this learned model, the system dynamically recalculates a delivery route and a loading plan with respect to a real-time traffic condition change. This technology is applicable to a home delivery business or a transportation and delivery management system of a wide-area supply chain.

By such a use case, each plan of warehousing and shipping, personnel allocation, transport robot operation, and delivery vehicle loading of the entire logistics center is optimized in real time and centrally by the generative AI, flexibly responds to a sudden demand fluctuation and an external environment change, minimizes risks such as a stockout, an excess inventory, a worker shortage, a robot failure, and a delivery delay, and can realize overall optimal logistics center operation. Specifically, the system aggregates multidimensional tensors output from the respective optimization units described above into a central integrated processing module. The central integrated processing module operates on a parallel computing cluster using a graphics processing unit. The central integrated processing module combines respective output data of a warehousing and shipping plan, a personnel allocation plan, a robot operation plan, and a vehicle loading plan, and generates a global state vector representing a state of the entire logistics center. The number of dimensions of the global state vector is, for example, 4096 dimensions. Elements of the global state vector include a predicted throughput, a resource operation rate, and a bottleneck occurrence probability of each department. As a specific example, the global state vector includes a congestion degree score of a picking area at 3:00 p.m., and an average battery consumption rate of a transport robot at the same time. The central integrated processing module inputs this global state vector to an overall optimization neural network. The overall optimization neural network adjusts a trade-off relationship among respective departments. The overall optimization neural network generates a resource reallocation command vector for each department as an output. A format of output data is a floating-point array defining an upper limit value and a lower limit value of processing capacity of each department. Each output value means a target operation rate of each department for maximizing overall throughput. As a specific example, the output data includes a control coefficient for reducing a processing speed of a warehousing department by 10% and improving a processing speed of a shipping department by 15%. The central integrated processing module feeds back this resource reallocation command vector to each optimization unit. Each optimization unit sets the received command vector as a new constraint condition, and recalculates each plan. By this processing, inefficiency of the entire system caused by partial optimization for each department is eliminated. This processing brings about a technical effect of dynamically maximizing processing capacity of the entire logistics center and improving robustness of the system against a fluctuation in an external environment. The overall optimization neural network optimizes a parameter by an evolutionary algorithm using an objective function that minimizes a total operation cost of the entire system. The system continuously executes this feedback loop in units of milliseconds. This technology is applicable to an integrated control system of a large-scale industrial facility or a smart factory in which a plurality of subsystems are complexly interlocked.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

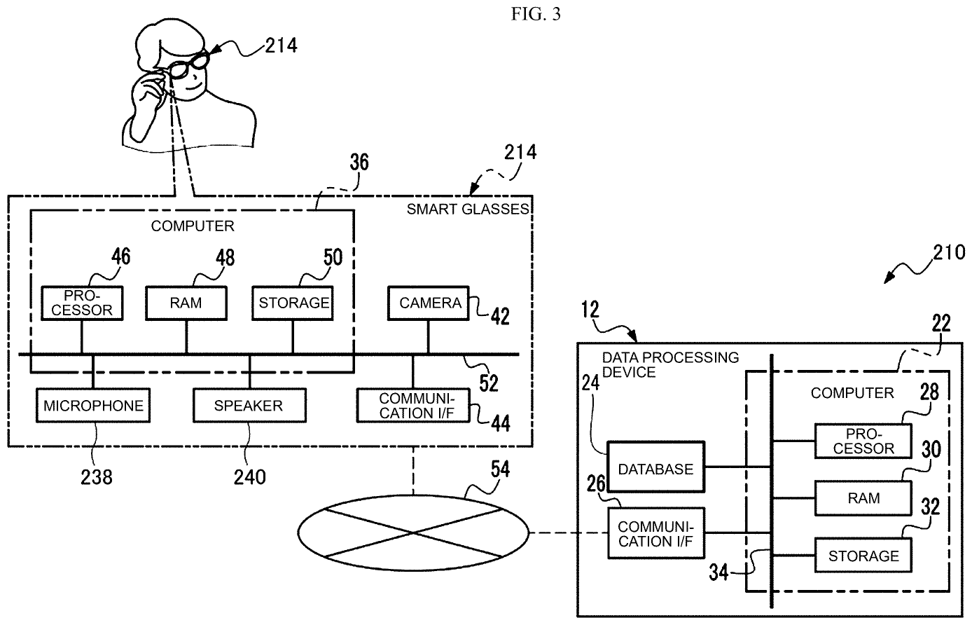

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

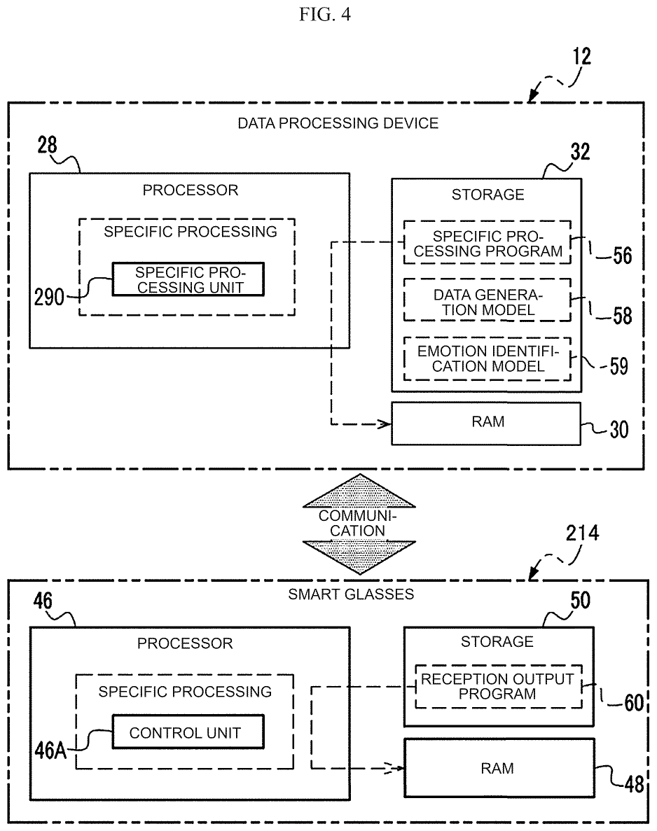

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

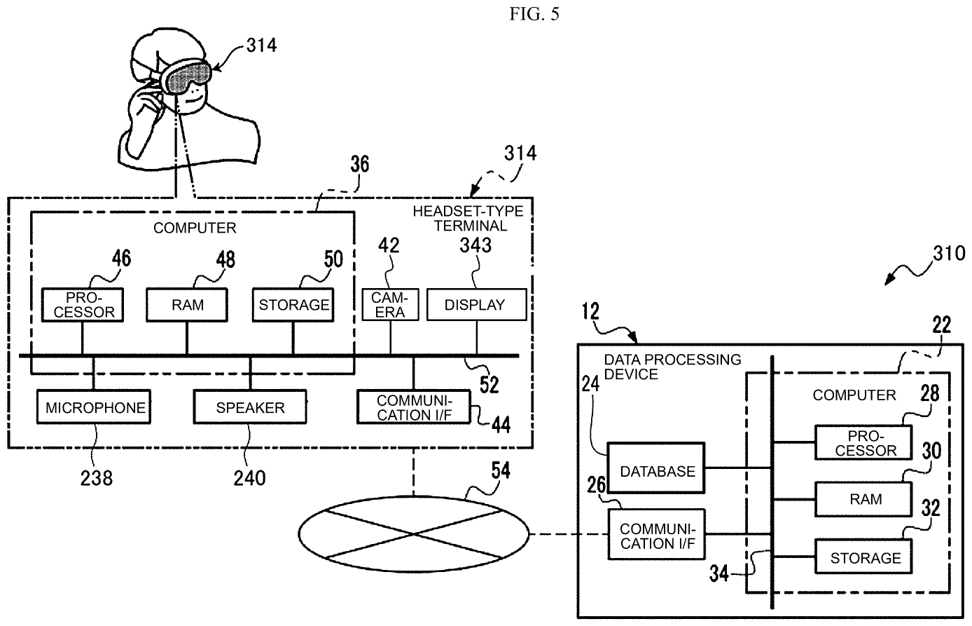

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

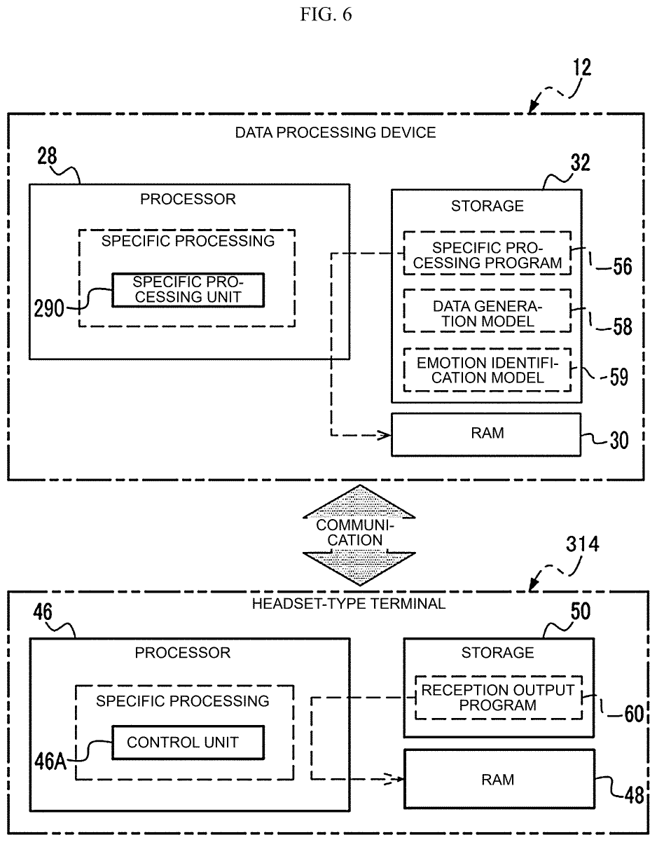

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

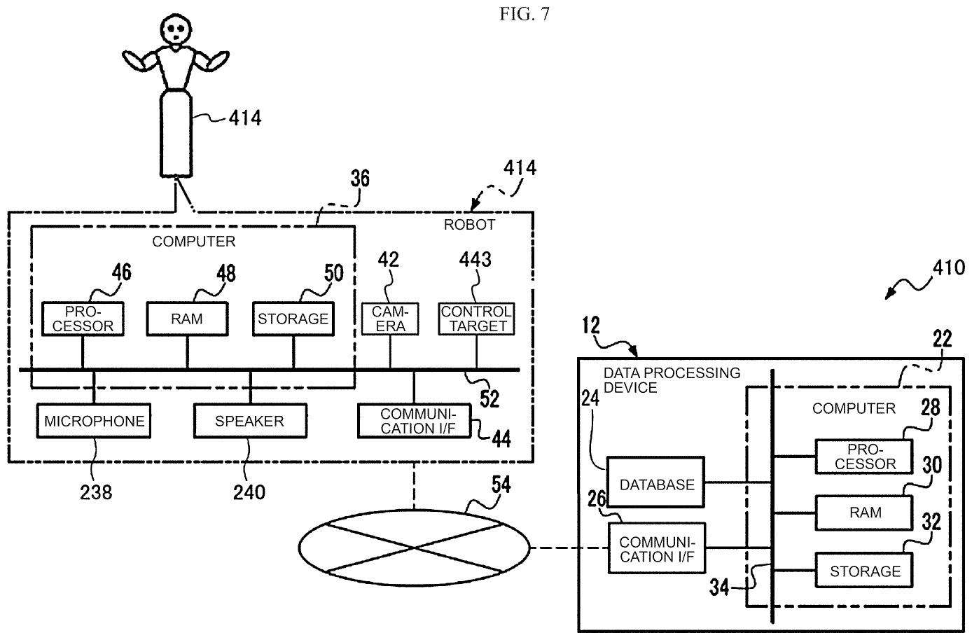

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

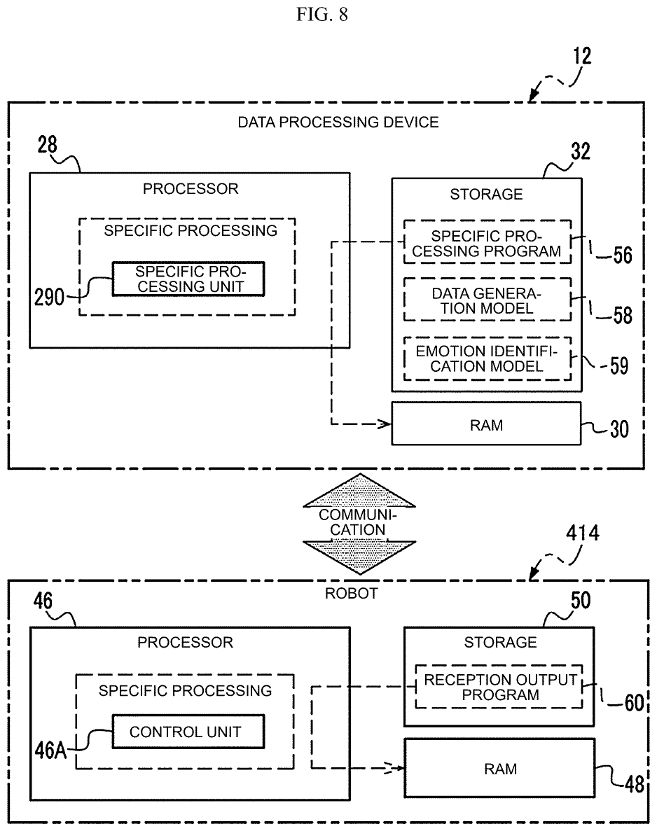

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

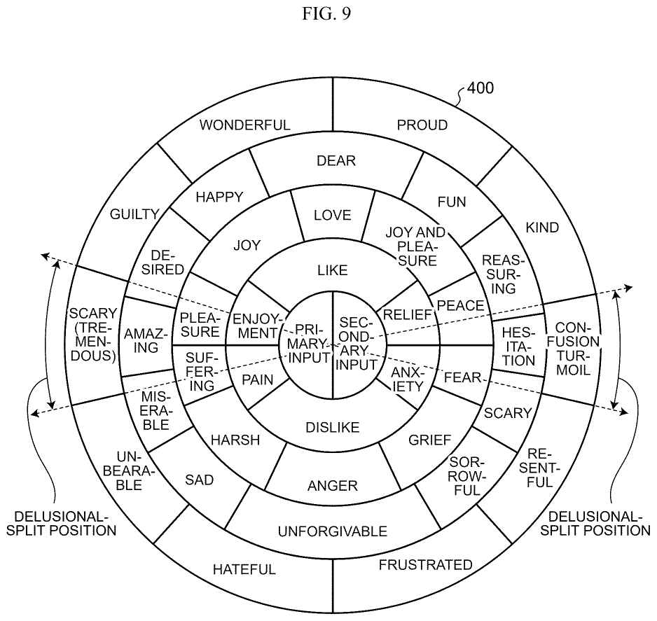

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

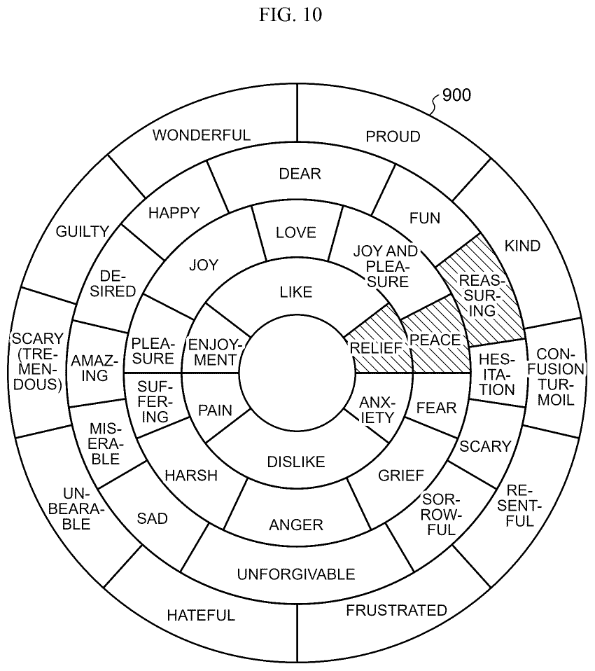

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A logistics center optimization system comprising: a warehousing and shipping optimization unit; a personnel allocation optimization unit; a transport robot operation planning unit; and a delivery vehicle loading planning unit, wherein the warehousing and shipping optimization unit is configured to integrate various data such as scheduled receiving data, scheduled shipping data, inventory data, weather data, and traffic condition data, learn a plurality of factors such as past shipping performance, seasonal fluctuations, demand fluctuations during campaigns, and shipping decrease during bad weather using generative AI, predict future shipping demand with high accuracy, and automatically generate a warehousing and shipping plan for preventing a stockout or an excess inventory by an optimization algorithm such as a linear programming method; the personnel allocation optimization unit is configured to analyze worker shift data, a workload, skills of each worker, a congestion status of a work area, a health condition of workers, and the like by generative AI, and determine an optimal personnel allocation for each work task such as picking, packing, loading, and sorting in real time; the transport robot operation planning unit is configured to analyze a current position of each robot, an operation status, a remaining battery level, a transport capacity for each robot, a congestion degree of the work area, and the like by generative AI, and automatically generate an operation plan for allocating an optimal robot to each work task; and the delivery vehicle loading planning unit is configured to analyze a loadable amount of each vehicle, a current location, an operable time, a delivery destination route, traffic congestion information, a delivery delay risk due to weather, and the like by generative AI, and automatically generate a loading plan for optimizing a loading allocation to each vehicle and a departure time based on a shipping demand prediction.

### Supplementary Note 2

The logistics center optimization system according to Supplementary Note 1, wherein the warehousing and shipping optimization unit is configured to input scheduled receiving data, scheduled shipping data, inventory data, weather data, traffic condition data, and further external economic indicator data, SNS trend data, competitor trend data, and the like into the generative AI, learn a correlation with past shipping performance and external factors, construct a model capable of predicting sudden demand fluctuations and a demand transition at the time of new product introduction with high accuracy, and automatically generate the warehousing and shipping plan for preventing the stockout or the excess inventory while maximizing an inventory turnover rate based on the model.

### Supplementary Note 3

The logistics center optimization system according to Supplementary Note 1, wherein the personnel allocation optimization unit and the transport robot operation planning unit are configured to dynamically analyze various parameters such as worker shift data, skill information, a health condition, a congestion status of a work area, an operation status of a transport robot, a remaining battery level, a transport capacity, a congestion degree of the work area, and a priority and urgency of each work task by the generative AI, and automatically generate a personnel allocation plan and a robot operation plan for simultaneously realizing leveling of a workload, optimization of personnel costs, maximization of robot operation efficiency, and optimization of battery consumption in real time.

What is claimed is:

1. A system comprising:
circuitry configured to:
receive, via a communication interface coupled to a packet-switched network, historical transaction data records, inventory state records, and external supply chain data records from a plurality of data source systems, and store the received data in a storage device;
apply a demand prediction model integrating historical sales performance data, inventory transition records, logistics lead time parameters, and supplier capacity parameters as input features to generate a demand forecast data record comprising predicted quantity values for each item-supplier combination;
apply a linear programming optimization model to the demand forecast data record and procurement constraint parameters comprising procurement cost values, maximum procurable quantity limits, logistics cost values, and lead time parameters to generate a procurement plan data record comprising optimal order quantity values and order timing parameters for each item-supplier combination;
apply an inventory simulation model to the procurement plan data record to generate simulated future inventory transition data, compute a service level metric and a holding cost metric from the simulation results, and generate a procurement plan adjustment recommendation when a service level metric falls below a service level target; and
transmit the demand forecast data record, the procurement plan data record, and a logistics optimization data record to terminal devices via the communication interface.

2. The system according to claim 1, wherein the circuitry is configured to receive streaming position data from automated transport vehicle sensor devices in a logistics facility via the communication interface, generate trajectory data from the position data, and apply a reinforcement learning model to the trajectory data and current task assignment records to compute optimal transport route sequences minimizing total travel distance.

3. The system according to claim 2, wherein the circuitry is configured to apply an automated transport vehicle operation planning model to current inventory location records and replenishment task records to generate a coordinated transport route plan for a plurality of transport vehicles, apply a collision avoidance algorithm to the transport route plan to detect route conflicts, and resolve detected conflicts by applying priority-based route assignment.

4. The system according to claim 1, wherein the circuitry is configured to apply a loading optimization model to freight volume parameters and vehicle capacity parameters to compute an optimal loading configuration for each delivery vehicle, and generate a loading instruction data record comprising item placement sequences and weight distribution parameters.

5. The system according to claim 1, wherein the circuitry is configured to apply a transformer-based time-series model to the historical transaction data records to generate multi-step ahead demand forecast values, apply the generative neural network model to incorporate unstructured external supply chain data comprising news article records and market condition reports as additional context, and update the demand forecast data record based on the incorporated external context.

6. The system according to claim 5, wherein the circuitry is configured to apply a Monte Carlo simulation procedure to the demand forecast data record to generate a probability distribution of future demand values, compute the fifth and ninety-fifth percentile demand values as lower and upper uncertainty bounds, and incorporate the uncertainty bounds as constraint parameters in the linear programming optimization model.

7. The system according to claim 1, wherein the circuitry is configured to apply the inventory simulation model by initializing virtual inventory state variables from current inventory state records, iterating forward in time by applying demand forecast values and procurement plan values at each time step, and recording inventory level trajectories, stockout events, and holding cost accumulation values.

8. The system according to claim 7, wherein the circuitry is configured to detect a potential stockout event in the simulated inventory trajectory when a simulated inventory level falls below a safety stock threshold parameter, generate a procurement plan adjustment recommendation specifying an increased order quantity or an earlier order timing for the affected item-supplier combination, and incorporate the adjustment recommendation in the procurement plan data record.

9. The system according to claim 1, wherein the circuitry is configured to apply a workforce allocation model to task workload data derived from the procurement plan data record to generate a personnel assignment data record assigning warehouse personnel to picking, packing, receiving, and shipping tasks, minimizing total labor cost while satisfying task completion deadline constraints.

10. The system according to claim 1, wherein the circuitry is configured to apply a supplier risk assessment model to supplier performance history records and external supply chain risk data retrieved from external data services via the communication interface, compute a supplier risk score for each supplier identifier, and incorporate supplier risk scores as penalty terms in the linear programming optimization model.

11. The system according to claim 1, wherein the circuitry is configured to deploy each optimization unit as an independent containerized microservice, execute the demand prediction model and the linear programming optimization model on graphics processing unit accelerators, and use a container orchestration tool to automatically scale each microservice based on processing load.

12. The system according to claim 1, wherein the circuitry is configured to apply the generative neural network model to the procurement plan data record to generate a natural language explanation of the procurement decisions, and transmit the natural language explanation to terminal devices associated with procurement management user identifiers for review.

13. The system according to claim 1, wherein the circuitry is configured to generate a logistics optimization data record by applying the generative neural network model to transport route data, vehicle capacity data, and delivery schedule data, and computing an optimal delivery routing assignment minimizing total delivery cost subject to delivery time window constraints.

14. The system according to claim 1, wherein the circuitry is configured to update the demand prediction model by generating training pairs from historical demand forecast data records and corresponding validated actual demand records, and fine-tune the model to reduce mean absolute percentage error on the most recent forecast window.

15. The system according to claim 1, wherein the circuitry is configured to generate an integrated operations dashboard data record from the demand forecast data record, procurement plan data record, inventory simulation results, and workforce allocation data, and transmit the dashboard data record to terminal devices associated with management user identifiers.

16. The system according to claim 1, wherein the circuitry is configured to store all demand forecast data records, procurement plan data records, and procurement plan adjustment recommendations in an audit log data structure with timestamps and user identifiers, and generate a performance history report comparing historical forecast accuracy against actual outcomes.

17. The system according to claim 1, wherein the data source systems provide historical transaction records, inventory state data, and supply chain parameters for a logistics processing facility, and the procurement plan data record specifies order quantities and timing for replenishing inventory at the facility.

18. A system comprising:
circuitry configured to:
receive, via a communication interface coupled to a packet-switched network, historical transaction records, inventory state records, and external supply chain data from data source systems;
apply a transformer-based demand prediction model incorporating external context to generate demand forecast data records with uncertainty bounds;
apply a linear programming optimization model with supplier risk scores to generate procurement plan data records, and apply an inventory simulation to compute service level metrics;
apply transport vehicle operation planning with collision avoidance and loading optimization; and
transmit demand forecasts, procurement plans, and logistics optimization data to terminal devices via the communication interface.

19. The system according to claim 18, wherein the circuitry is configured to apply a Monte Carlo simulation to generate demand probability distributions for incorporation as optimization constraints, apply a workforce allocation model to generate personnel assignment data records, and deploy each optimization unit as an independent containerized microservice with GPU-accelerated inference.

20. A method comprising:
receiving, via a communication interface coupled to a packet-switched network, historical transaction data records, inventory state records, and external supply chain data, and storing the data in a storage device;
applying a demand prediction model to generate a demand forecast data record comprising predicted quantities for each item-supplier combination;
applying a linear programming optimization model to generate a procurement plan data record comprising optimal order quantities and timing parameters;
applying an inventory simulation model to generate service level metrics and generate procurement plan adjustment recommendations; and
transmitting the demand forecast data record, the procurement plan data record, and a logistics optimization data record to terminal devices via the communication interface.
